(19) United States
(12) Patent Application Publication
(10) Pub. No.: US 2013/0029884 A1
(43) Pub. Date: Jan. 31, 2013

(54) BIOCIDE FORMULATIONS

(71) Applicants: Paul S. Malchesky, Painesville, OH (US); George E. Grignol, Fairview, PA (US); J. Lloyd Breedlove, Statesville, NC (US)

(72) Inventors: Paul S. Malchesky, Painesville, OH (US); George E. Grignol, Fairview, PA (US); J. Lloyd Breedlove, Statesville, NC (US)

(73) Assignee: ENVIROSYSTEMS, INC., Mooresville, NC (US)

(21) Appl. No.: 13/555,799

(22) Filed: Jul. 23, 2012

Related U.S. Application Data
(60) Provisional application No. 61/512,017, filed on Jul. 27, 2011.

(51) Int. Cl. C09K 8/86; A01N 31/12; A01P 1/00; A01N 65/06

(52) U.S. Cl. 507/219; 424/770; 514/737; 507/266; 507/203

(57) ABSTRACT

Biocide compositions comprising biocide, surfactant, and solubilizing agent. The preferred biocide is parachlorometaxylenol. The biocide composition is useful in oil and gas drilling operations, such as hydraulic fracturing, as well as treating aqueous slurries in ore mining operations. The biocide compositions are effective in controlling microorganisms even in the presence of high salt content water and at high temperatures.

### TECHNICAL FIELD

The present invention relates to biocide formulations, their preparation and their uses including their use in oil and gas exploration and production as well as ore and mineral processing slurries, such as in the production of paper, wood, pulp, and kaolin clay and their products that require control of microorganisms. The biocide formulations can also be used as additives to water-based solutions, such as in latex paints to control undesirable properties such as odor, staining and discoloration due to microorganisms.

### BACKGROUND

As an example of an application, after a well is drilled into a subterranean geological formation that contains oil or natural gas, the well is frequently treated to increase the production of oil and/or natural gas. A well can be drilled vertical until reaching a shale formation containing oil or gas and then drilled horizontal in the shale formation to release the oil or gas. One common treatment is to employ hydraulic fracturing. In hydraulic fracturing a fluid containing mostly water along with friction reducers, proppants (such as sand), biocides, oxygen scavengers, polymers, and other chemicals to prevent corrosion of metal pipes are used. The fluid is pumped at large volumes and under high pressure into the well. The high pressure fluid, which exceeds the strength of the rock or shale formation, will migrate along rock or shale formations which have been opened by the fluid, and create channels in the rock or shale formation. These channels, which can extend for several hundreds of feet, provide additional paths for the oil and/or natural gas to migrate to the well bore hole, thus improving the production of the well. The proppant, which is usually sand, is carried by the fluid into the channels formed and helps to maintain the channel in an open position, once the pressure is reduced and the fluid is partially removed from the well.

The hydraulic fracturing fluids contain a biocide to inhibit the growth of microbes. The biocide used must have several attributes to be successful. The biocide must control the sulfate reducing bacteria (SRB); slime producing bacteria (SPB) and acid producing bacteria (APB) and other microorganisms. The growth of these bacteria can hinder the flow of oil or natural gas through the channels formed by hydraulic fracturing and also cause the natural gas to become “sour.” Sour gas will be required to undergo further treatment before being used in commerce.

The fluid used in hydraulic fracturing can be relatively pure before being pumped down the well. Once the fluid is in contact with the subterrain surface, it can come in contact with various salts found at these extreme depths. Potassium, calcium, barium, magnesium, and sodium salts are common contaminants that the fluids encounter. Thus, the biocide must be effective when salts are present. The biocides must also be effective at elevated temperatures, which can reach temperatures of up to 85° C. and higher. Also, because of the large volume of water used and because the wells are usually in remote locations, the water can be sourced from many sources. Ponds, lakes, and river waters are frequently used and these waters can have various salts and microbes in them.

The biocides used in hydraulic fracturing must not only inhibit the growth of microbes, but also have several other properties. They should be gentle and safe for the environment, the equipment coming in contact with it, and any personnel working with it. They should have extended shelf life, be effective when used under aerobic and anaerobic conditions, active over a wide pH range, non-oxidizing, non-reactive with other chemistries used with it or in association with such applications.

In addition to the hydraulic fracturing fluid, several other water based fluids used in the oil and natural gas drilling and production operation benefit from the use of a biocide. These other fluids include drilling waters, drilling muds, field water systems, flood water for enhanced recovery systems, injection waters, holding pond water, disposal-well water, and water holding tanks. Uses in fields other than the oil and natural gas industries that require a biocide include ore and mineral processing slurries, such as in the manufacture of kaolin (clay). Also, the wood and pulp industry such as the production of paper and other wood products, require a biocide in their processes. Biocides are also used in polymers, films, porous and nonporous structures to prevent the growth of microorganisms which can cause undesirable properties. Generally, biocides can be applied to any water based solution that is vulnerable to microbial contamination.

Several prior art references disclose various biocides for use in oil field applications and mineral slurries.

U.S. Pat. No. 4,552,591 discloses a biocide composition for oil field fluid polymers and oil field water polymers where a biocide is absorbed on the surface of a solid, particulate absorbent and lessens personal and environmental contamination by spilled or splashed liquid biocides. The biocide is a mixture of 5-chloro-2-methyl-4-isothiazolin-3-one and 2-methyl-4-isothiazolin-3-one.

U.S. Pat. No. 5,637,587 discloses an antimicrobial composition comprising 1-(3-chloroallyl)-3,5,7 triaza-1-azoniaadamantane chloride and 2-bromo-2-nitropropane-1,3-diol. The reference also provides a method for inhibiting microbial growth in an aqueous mineral ore slurry, e.g., kaolin slurry, by adding a microbicidal composition to the slurry comprising the above mentioned biocides.

U.S. Patent Application 20080032903 discloses a well stimulation and treatment fluid that includes water, a polymer from the group of galactomannan polymers, derivatized glactomannan polymers, starch, xanthan gums, hydroxyl celluloses, polyvinyl alcohol polymers, copolymers of vinyl alcohol and vinyl acetate, and a biocide of 2,5-dimethyl-1,3,5-thiadiazinane-2-thione (Dazomet). Also disclosed is adding an effective amount of 2,5-dimethyl-1,3,5-thiadiazinane-2-thione to the well stimulation fluid.

U.S. Patent Application 20100137168 discloses nanoemulsions useful to the oil fields and more particularly water-in-oil, oil-in-water, and other classes of nanoemulsions found beneficial in drilling, well remediation, and other oil and gas industry related operations. Additionally, nanoemulsions may reduce friction pressure losses, as well as reduce subsidence of solid weight material during oil and gas operations. There is no mention of incorporating a biocide in this application.

The prior art biocides have various shortcomings. Some are rather toxic to personnel handling them or to the environment. Others do not work well in the presence of high salt concentrations or at higher temperatures. Still others are corrosive to equipment or interfere with other chemistries used in oil and gas production. Still others are so reactive that they have limited use life.

Some prior art biocides and their shortcomings are discussed below. The biocide 2,5-dimethyl-1,3,5-thiadiazinane-2-thione (referred to as ICI 3240 or Dazamet) is supplied at a pH of 12-14 and has a hydrolysis half life of 0.15 days. Glutaraldehyde, known for its fixative/crosslinking properties is a known toxin and of environmental concern, can have a deleterious affect on the fluid viscosity. Tetrakis hydroxylmethyl phosphonium sulfate (THPS) is toxic category 1 (toxic) at 20% concentrations, requires an activation step to release formaldehyde (a known carcinogen), has been found to interact with the polymer and limit viscosity development when added pre-inversion and post-inversion, and has demonstrated metabolism under only anaerobic conditions. Dibromocyanoacetamide (DBNPA) degrades to ammonia and bromide ion, in the liquid formulation is an oxidizer, is highly corrosive at pH 2-3.5, and requires special disposal requirements. Sodium hypochlorite is a strong oxidizing agent, corrosive, toxic, and is reactive with ammonia to produce chloramines, with acids to produce chlorine gas, with organic matter to produce toxic disinfectant by-products, and with surfactants and fragrances to produce chlorinated toxic, volatile organic compounds (VOC). Electrochemically activated solution (ECA) must be generated on site, has a short shelf life, is a strong oxidizing agent, and shows reduced efficacy with organic loads. Chlorine dioxide must be generated on site due to its limited shelf life and its explosiveness at concentrations of 15% or higher, is a strong oxidizing agent, and shows reduced efficacy with organic loads. Quaternary ammonium compounds are cationic surfactants with toxic effects by all routes of exposure, concentrated solutions are corrosive, they can be inactivated by anionic compounds, and they have corrosive effects on metals, such as brass and copper, and vinyl. Methylene bisthiocyanates are pH sensitive and rapidly hydrolyzes at pH>8. Isothiazolinones are potent skin sensitizers and bacterial mutagens and causative for dermatitis. Thiocarbamates are volatile, possible sensitizers, show neuropathology toxicity, and are not compatible with polyurethane, milk steel, aluminum, brass, copper, and other plastics. Bronopol (2-bromo-2 nitropropane-1,3-diol) has potential for nitrosamine and formaldehyde formation on decomposition (suspected carcinogens).

There is a long felt need for a biocide formulation which will not have the shortcomings mentioned above.

### SUMMARY

It is an object of this invention to provide a biocide formulation (composition) which can be used in oil and gas exploration and production to treat hydraulic fracturing fluid.

It is a further object of this invention to provide a biocide formulation which is effective for treating other water used in the oil field, such as drilling water, field water systems, flood water, injection water, holding pond water, disposal well water and water holding tanks.

It is a further object of this invention to provide a biocide formulation which can be used in the processing of ore and mineral slurries, in the wood and pulp industry, and in the polymer, films, porous and nonporous structures. The biocide formulation is used to kill and prevent the growth of microorganisms.

It is another object to provide a biocide formulation that is safe for personnel working with the biocide formulation; the materials/equipment in contact with it, and is environmentally friendly.

It is also an object to provide a biocide formulation which is noncorrosive to equipment used, is effective at high salt concentration of field water, and does not interfere with other chemistries used in the hydraulic fracturing fluids, such as oxygen scavengers, hydrogen sulfide, and iron.

It is a further object that the biocide formulation be provided in a concentrate form which can be safely transported to the point of use, such as the well site, where it would be added to the fluid needing protection from microorganisms. The term biocide formulation and biocide composition are used interchangeably herein.

The above objects are accomplished by an embodiment of a biocide formulation comprising:

(a) water;

(b) at least one biocide selected from the group consisting of (i) a halogen substituted xylenol compound, (ii) a phenolic compound, (iii) an antimicrobial natural or essential oil, (iv) an antimicrobial component from natural or essential oil, and (v) combinations of at least two of (i), (ii), (iii) and (iv);

(c) at least one surfactant, wherein said surfactant is selected from the group consisting of anionic surfactant, amphoteric surfactant, nonionic surfactant, and blends thereof;

(d) at least one solubilizing agent; and

(e) optionally, said biocide formulation may also comprise ingredients selected from the group consisting of pH adjusters, metal chelators, and viscosity modifiers.

In a preferred embodiment, the biocide in the biocide formulation is parachlorometaxylenol (CAS No. 88-04-0).

In another embodiment, the surfactant in the biocide formulation is selected from the group consisting of potassium ricinoleate, sodium dodecyl sulfate, sodium lauryl ether sulfate, D-glucopyranose oligomeric decyl octyl glycosides, and mixtures thereof.

In a further embodiment, the solubilizing agent in the biocide formulation is selected from the group consisting of alpha-terpineol, propylene glycol, deionized water, and mixtures thereof.

In a preferred embodiment, the biocide formulation is a concentrate which comprises from about 5 to about 15 weight percent of the active biocide, but lower and higher concentrations are possible.

In another embodiment, the concentrated biocide formulation is added to field water to yield an active biocide component of from about 5 or less to about 5000 parts per million (ppm) in the resulting mixture. Preferably, the concentration of the biocide component is from about 100 to about 500 ppm.

### DETAILED DESCRIPTION OF EXEMPLARY EMBODIMENTS

The first necessary ingredient of the biocide formulation of this invention is the biocide. In one embodiment the biocide is a halogen substituted xylenol, with the preferred biocide being parachlorometaxylenol (hereinafter referred to as PCMX). PCMX is also known as 4-chloro-3,5-dimethyl-hydroxy benzene, 4-cholor 3,5-dimethyl phenol, 4-chloro 3,5 xylenol, and 4-chloro meta xylenol. PCMX is a chlorine substituted xylenol with a molecular formula of C₈H₉Cl0 and has a molecular weight of 156.5 with a CAS No. 88-04-0. PCMX's mechanism of antimicrobial action is by the denaturation of proteins and inactivation of enzymes in the microorganisms. Also likely, this agent, as for other phenolic compounds, alters the permeability of the cell membrane that could result in the uncoupling of oxidative phosphorylation, inhibition of active transport, and loss of pool metabdites due to cytoplasmic membrane damage. Compared to phenols, xylenols exhibit increased microbiocidal activity, on the order of from 30 to 60 times more. The chlorine substitution intensifies the microbiocidal potency.

Other biocides which may be used include phenols and substituted phenols, triclosan, trichlocarban, other phenolics such as para tertiary amylphenol (PTAP), o-benzyl-p-chlorophenol (BCP), and ortho-phenyl-phenol (OPP). Other biocides include benzalkonium chloride, benzethonium chloride, biguanide, and chlorohexidine gluconate.

As mention above, the halogen substituted xylenol (PCMX) is the preferred biocide, because it is very effective and environmentally friendly. However, one or more biocide may be used in combination with another biocide.

In another embodiment, the biocide is an antimicrobial natural or essential oil, which can be a natural or synthetic version, or components from such oils that are known to be antimicrobial. Natural or essential oils include terpineol, thyme, wild thyme, red thyme, thyme white, thymol, origanum, oregano and a main constituent carvacrol, lemongrass, lemon, orange, lime, lavender and its constituents lavandin and lavandula, tea tree and its constituents including terpinen-4-ol, wintergreen, eucalyptus and its components as 1,8-cineol and eucalyptol, menthol, cornmint, laurel, ziziphora, bay, sweet orange, cinnamon, cinnamon bark, rose, rosewood, clove, peppermint, rose geranium, geranium, meadowsweet, anise, orris, mustard, rosemary, cumin, neroli, birch, Melissa balm, ylang ylang, juniper, sweet fennel, garlic, cajeput, sassafras, heliotrope, pine, pine oils, parsley, violet, coriander, citron, citronella, patchouli, bergamot, sandalwood, eugenol, verbenone, geraniol, limonene, fennel, sesame, geraniol, hinokithiol, citral, terpinene, citronellal, citronellol, linalool, anethole, inenthone, carvone, camphor, and mixtures and components from such.

In another preferred embodiment, the biocide is a combination of PCMX and essential oil or components thereof.

The biocide formulation also contains as a necessary ingredient at least one surfactant. In one embodiment the surfactant is selected from the group consisting of anionic surfactant, amphoteric surfactant, nonionic surfactant, and blends thereof. Anionic surfactants include alkyl sulfates such as sodium lauryl sulfate, sodium laureth sulfate of various levels of ethoxylation, TEA lauryl or laureth sulfate, MEA lauryl or laureth sulfate, potassium lauryl or laureth sulfate, sodium dodecyl sulfate, sodium octyl/decyl sulfate, sodium 2-ethyl-hexyl sulfate, sodium octyl sulfate, alkyl ethoxylates, alkyl ethoxylate sulfates, alkyl aryl sulfates, alkyl aryl sulfonates, sodium C14-C17 alkyl sec. sulfonate (paraffin sulfonate or sodium petroleum sulfonate), fatty acid soaps, natural acids saponified such as ricinoleate, alkylsulfonic acid salts, fatty alcohol sulfates, sodium xylene sulphonate, ammonium xylene sulphonate, sodium toluene sulphonate, sodium cumeme sulfate and other hydrotropes, alkyl phosphates as lauryl phosphate, sulfosuccinates as disodium lauryl and laureth sulfosuccinates, alphaolefin sulphonate, and alkyl phenol ether sulfate. Anionic surfactants such as derived from natural sources or recognized as GRAS (Generally Recognized As Safe) that are environmentally friendly are preferred.

Suitable amphoteric surfactants includes the general class of alkyl betaines as laurylamidopropyl betaine, oleyl betaine, ether amine oxides as lauryl dimethyl amine oxide, alkyl oxy propylamine dipropionate (amphoteric 12 as supplied by Air Products), cocoamidopropyl dimethyl amine oxide, phospholipids composed of diester and triester phosphatides, and naturally derived surfactants such as lecithins. Amphoteric surfactants such as derived from natural sources or recognized as GRAS that are environmentally friendly are preferred.

Suitable nonionic surfactants includes various linear or non-phenol alcohols or fatty acids, ethers of fatty alcohols, octylphenoxy polyethoxyethanol 2-dodecoxyethanol, ethoxylated alcohols, ethoxylated amines, ether amines and ether diamines as cocoamid DEA, cocoamide MEA, ethoxylated amines, esters as ethylene glycol monostearate, ethylene glycol distearate as polyoxyethylene sorbitan esters, polysorbates, linear ethylene oxide/propylene oxide and/or butylenes oxide block copolymers, poly(5) oxyethylene isodecyloxypropylamine, poly (5) oxyethylene isotridecyloxypropylamine, glycols such as propylene glycol, amine oxides as long chain alkyls, polyoxypropylene—polyoxyethylene block copolymers as methyl-oxirane polymer with oxirane, ethoxylated castor oil (castor oil polyoxyethylene ether), coco ethoxylated fatty acids (PEG-12 cocoate) and ethoxylated monoethanolamide of fatty acids of coconut oil (PEG-11 cocamide). Preferred nonionic surfactants include polysorbates as Tween 20, 40, or 80, Igepal, Tritons, and glucosides as decyl glucoside, lauryl glucosides, octyl glucosides, D-glucopyranoside C10 to C16 alkyl oligomer, D-glucopyranoside C6 to C12 alkyl oligomer, and ethyloxated amines and alcohols. These preferred nonionic surfactants readily biodegrade, are environmentally friendly and are gentle.

The biocide formulation of this invention also contains as a necessary ingredient at least one solubilizing agent. The solubilizing agent is necessary because many biocides, such as PCMX, are not soluble or very slightly soluble in water. The combination of the surfactant and solubilizing agent allows a stable emulsion to be made.

Suitable solubilizing agents include low molecular weight alcohols such as ethanol, propanol, isopropanol, glycols such as propylene glycol and polypropylene glycols. Ethanol, isopropyl alcohol, and propylene glycol are among the preferred solubilizing agents. Other preferred solubilizing agents include the cyclic terpenes such as pine oils and their components as the monoterpene alcohols, terpineols, or pine oil derivatives and their isomers alpha, beta and gamma, and aldehydes and ketones therefrom, limonenes including d-limonene, dipentenes, terpene hydrocarbons and terpene processing by-products and hydrocarbons including terpenes and terpenoids, turpentine—oil, myrcene fraction, hydroxyl, acetates, and 2,6-octadien-1-01,3,7-dimethyl-(2Z), and alcohols C10-terpenoidal, and benzene 1-methoxy-4-(1E)-1-propen-1-yl-.

Another necessary ingredient of the biocide formulation is water. Any normal source of water can be used as long as the water is reasonably clean and does not contain an excess of dissolved salts. In making the concentrated biocide formulation suitable for later use, deionized water is highly recommended to provide consistent quality.

The biocide formulation may optionally contain other ingredients, such as but not limited to pH adjusters, metal chelators, and viscosity modifiers.

Formulation pH adjusters include mineral acids and bases and organic acids and amines A preferred pH adjuster is hydrochloric acid and citric acid, and a preferred pH range is 6 to 9, and more preferred is 7.5 to 8.5. Metal chelators include various chemical agents to chelate or sequester metal ions in water. Some examples of chelators include organic acids, such as citric acid, sodium and potassium salts of ethylene diaminetetraacetic acid and nitrilotriacetic acid, sodium and potassium salts of methyl glycine diacetic acid, and bisphosphonates. To affect a decrease in the viscosity of the usable fluid solution, friction reducers can be employed. Friction reducers may include anionic, cationic, or amphoteric polyacrylamindes.

The preferred biocide formulation is made in a concentrated form as an emulsion using PCMX as the biocide or a mixture of PCMX and antimicrobial essential oils and/or components of such oils and mixtures thereof. The preferred biocide formulation is one utilizing a high flash point solubilizing agent, such as a glycol that reduces significantly the flammability of the formulation. By making the biocide in a highly concentrated form, advantages are achieved by limiting the volume needed to ship and a reduced shipping cost. The preferred concentrations of the biocide formulation are sufficiently low to be safe in their diluted and use form, environmentally friendly and sustainable, and safe to handle, to the user, and to equipment and/or materials that it needs to come in contact with, yet effective for bacterial control or kill. It is preferred that the surfactants be derived from natural and sustainable products, such as castor oil based anionic surfactant such as the potassium salt of ricinoleic acid with or without a cosurfactant such as sodium dodecyl sulfate or nonionic surfactants of various structures.

The preferred biocide formulation in concentrated form will have from (a) about 1 to about 20 weight percent biocide, preferably from about 5 to about 15 weight percent, and more preferably from about 8 to about 12 weight percent. The preferred biocide formulation in concentrated form will also have from (b) about 2 to about 50 weight percent surfactant, preferably from about 10 to about 40 weight percent. The preferred biocide formulation in concentrated form will also have from (c) about 20 to about 50 weight percent solubilizing agent. The remainder of the formulation is preferably deionized water.

The concentrated biocide formulation is added to water needing a biocide, such as hydraulic fracturing fluid or a mineral processing slurry in a concentration to give a level of the biocide from about 5 to about 5000 ppm, preferably from about 100 to about 500 ppm. Of course, the level used will depend on the fluid treated and the level of microorganisms in the fluid originally or after being used for its intended purpose. The level used can be adjusted higher or lower depending on the requirement in the particular field use.

Three specific highly preferred biocide formulations in concentrated form are as follows:

| | | Formu- | Formu- | Formu- | |
|---|---|---|---|---|---|
| | | lation 1 | lation 2 | lation 3 | |
| Component | Cas No. | Weight % | Weight % | Weight % | Purpose |
| PCMX | 88-04-0 | 10.2 | 10.2 | 10.2 | Biocide |
| Potassium | 7492-30-0 | 12.0 | — | — | Sur- |
| ricinoleate | | | | | factant |
| Sodium | 151-21-3 | 3.0 | — | — | Sur- |
| dodecyl | | | | | factant |
| sulfate | | | | | |
| Sodium | 68585-34-2 | — | 30.0 | 28.3 | Sur- |
| lauryl | | | | | factant |
| ether | | | | | |
| sulfate | | | | | |
| D-gluco- | 68515-73-1 | — | 10.0 | 9.5 | Sur- |
| pyranose, | | | | | factant |
| oligomeric, | | | | | |
| decyl octyl | | | | | |
| glycosides | | | | | |
| Alpha- | 98-55-5 or | 10.9 | 10.9 | — | Solu- |
| Terpineol/ | 8000-41-7 | | | | bilizing |
| Pine oil | | | | | Agent |
| Propylene | 57-55-6 | 20.0 | 15.7 | 30.0 | Solu- |
| glycol | | | | | bilizing |
| | | | | | Agent |
| Water | | 43.9 | 23.2 | 22.0 | |
| | | 100 Wt. % | 100 Wt. % | 100 Wt. % | |

The main differences in the above three highly preferred biocide formulations is in the surfactant system used and in Formulation 3 the use of a single solubilizing agent. All formulations have a pH of from 8.0 to 8.6. Formulations 2 and 3 have proven to be better at high salt concentrations of the field water to be treated. Both formulations are highly effective for killing microorganisms.

Although the biocide formulations of this invention can be used in many applications, their primary focus is in treating oil field waters, particularly hydraulic fracturing fluids used in oil and gas production. The term “field water” as used herein means water obtained from any source but usually obtained from pond, river, stream, lake, water well, recycled water from a previous hydraulic fracturing job, treated water, and mixtures thereof. A single well normally uses 3 to 5 million gallons of water in a hydraulic fracturing procedure. Typically 10% to 15% of this water used will return to the surface as waste water. The waste water normally has high concentrations of salt and metals and therefore must be treated before disposal or re-use.

The three biocide formulations shown above are designed to be gentle and safe for the environment, the equipment coming in contact with it, and any personnel working with it. All formulations have an extended shelf life. They are effective when used under aerobic and anaerobic conditions, are active over a wide pH range, and are non-oxidizing, non-reactive with other chemistries used with it or in association with below ground applications and can be supplied as a concentrate to minimize shipping and transportation costs.

The biocide formulations of this invention are low toxicity (Category IV for oral, inhalation and dermal exposure) and thus safe for personnel use, no special handling requirements, and non-carcinogenic. The formulations also have a high flash point (greater than 200° F.) and thus are not an explosion hazard. Formulations 2 and 3 shown above are stable at varying concentrations of salt (mono and divalent) up to 12.5 Wt. % and are stable at up to 500 ppm biocide concentration in high salt (12.5 Wt. %) solutions. Tested formulation of the type 2 and 3 when tested are also stable at temperatures up to at least 189° F. (87° C.) tested.

### EXAMPLES

The following examples 1-78 are shown to give specific formulations of biocide formulations which are concentrates designed to be further diluted within this invention. All % and ppm (parts weight per million) of the formulations are expressed as weight % or weight ppm unless otherwise indicated.

### Example 1

A composition having 6% potassium ricinoleate (surfactant), 10% isopropyl alcohol (solubilizing agent), 10% terpineol (solubilizing agent), 5% PCMX (biocide), with the remainder deionized water was made. The pH was adjusted with concentrated hydrochloric acid to pH 8.5.

Microbiological studies were carried out with the formulation of Example 1 and compared to tests with other known biocides. The field water used for testing came from a well in Texas. The biocides were tested at varying concentrations of the active biocide in the field water at active biocide concentrations from 94 parts per million (ppm) to 500 ppm. The biocide of Example 1 was tested along with several known biocides. The known biocides included 2,5-dimethyl-1,3,5-thiadiazinane-2-Thione (Dazomet), tetrakis hydroxylmethyl phosphonium sulfate (THPS), glutaraldehyde, and dibromocyanoacetamide (DBNPA). In general, the kill of sulfate reducing bacteria (SRB) and acid producing bacteria (APB) varied as a function of the concentration for the individual biocides. At 94.2 ppm of PCMX, there was complete kill of SRB and APB. There was not complete kill when using Dazomet at 270 ppm. There was complete kill at 150 ppm THPS, and complete kill at 250 ppm glutaraldehyde, and complete kill with 20 ppm DBNPA. This Example shows the effectiveness of the biocide formulation of this Example 1 to kill SRB and APB at a concentration of 94 ppm active PCMX.

### Example 2

A composition with 12% potassium ricinoleate, 20% isopropyl alcohol, 20% terpineol, 10% PCMX, with the remainder deionized water was made. The pH was adjusted with concentrated hydrochloric acid to pH 8.5.

### Example 3

A composition with 12% castor oil salts, 20% isopropyl alcohol, 20% pine oil 150, 10% PCMX, with the remainder deionized water was made. The pH was adjusted with concentrated hydrochloric acid to pH 8.51.

### Example 4

A composition with 12% potassium ricinoleate, 20% isopropyl alcohol, 20% terpineol, 10% PCMX, with the remainder deionized water was made. The pH was adjusted with concentrated hydrochloric acid to pH 8.51.

### Example 5

A composition with 6% potassium ricinoleate, 1.5% sodium dodecyl sulfate, 8.75% isopropyl alcohol, 1.25% phenoxetol, 5.45% terpineol, 5% PCMX, 1% polyphosphate, with the remainder deionized water was made. The pH was not adjusted and was 8.33.

Microbiological kill studies were carried out in field waters considered to be problematic. Concentrations of up to 150 ppm PCMX final concentration were evaluated per the standard “Determining Loading Volumes for Sample Water and Biocides.” PCMX concentrations of >100 ppm showed complete control of APB, SRB, and slime producing bacteria (SPB). There was no discrimination in kill among the different bacterial species.

### Example 6

A composition with 6% potassium ricinoleate, 1.5% sodium dodecyl sulfate, 8.75% isopropyl alcohol, 1.25% phenoxetol, 5.18% terpineol, 0.27% lemongrass, 5% PCMX, 1% polyphosphate, with the remainder deionized water was made. The pH was not adjusted and was 8.37.

### Example 7

A composition with 12% potassium ricinoleate, 3% sodium dodecyl sulfate, 20% propylene glycol, 10.9% terpineol, 10% PCMX, with the remainder deionized water was made. With various individual batches made, the pH was adjusted with concentrated hydrochloric acid to 8.52 to 8.56.

Microbicidal studies were carried out with the formulation of this Example 7. A field water sample was used to dilute the formulation and growth media was added. The testing was per the standard “Determining Loading Volumes for Biocides.” The samples to be tested were placed in bottles and observed for growth of bacteria. Control samples (no biocide) showed that for sulfate reducing bacteria (SRB), 5 bottles turned (showed growth) at five days and for acid producing bacteria (APB) at one day. For the SRB concentrations up to 150 ppm PCMX were studied. Significant reductions in SRB were seen at concentrations ≧100 ppm and shown to be directly related to the PCMX concentration. For the APB samples, concentrations of up to 100 ppm PCMX were studied. A significant reduction in APB was seen at 100 ppm PCMX. The diluted sample was also tested after the sample had experienced four freeze/thaw cycles and the sample with growth media added was tested with PCMX concentrations up to 100 ppm PCMX. A significant reduction in SRB and APB were seen at 100 ppm PCMX concentration. The repeated freezing process did not have any significant effect on the microbicidal properties of the formulation.

A comparable laboratory study was conducted using two field waters with high hydrogen sulfide concentrations of 42 and 24 ppm respectively. These waters were not supplemented with growth media and the controls showed significantly lower numbers of bottles that turned for the SRB and APB. For the 42 ppm hydrogen sulfide concentration water, testing was carried out with PCMX concentrations up to 100 ppm. At the concentration of 100 ppm PCMX, there was significantly better control of SRB and APB, with no more than one bottle showing growth after 10 days of study. For the 24 ppm hydrogen sulfide concentration water, testing was carried out with PCMX concentrations up to 125 ppm. At concentrations of 100 ppm and higher PCMX, there was significantly better kill and less bottles showing bacterial growth.

The formulation of this Example 7 was tested by an independent laboratory for microbiological testing at a concentration of 200 ppm PCMX in deionized water and in a 2.5 wt. % sodium chloride solution at room temperature (23±2° C.). The organisms studied were Bacillus cereus ATCC #35857, Pseudomonas Fluorescens ATCC #13525, and Aspergillus niger spores. The contact times for testing were 1 and 3 hours. For the vegetative bacteria Bacillus cerus and Pseudomonas fluorescens at all times and for both organisms the number of organisms remaining were <1 organism. The log reductions were greater than 6 logs demonstrating significant antibacterial activity. For the A. niger spores tested with 2.5 wt. % sodium chloride the reductions in bacteria reductions were 91.04% and 92.74% at 1 and 3 hours, respectively.

Toxicological studies were also carried out on this formulation of Example 7. In an acute dermal irritation testing in albino rabbits, the formulation was rated as slightly irritating and assigned to Toxicity Category IV per Proposed Rule, FR Vol. 49, No. 188. In an acute dermal toxicity and relative skin irritancy testing in albino rats, the formulation had an LD50 of greater than 5050 mg/kg body weight in males and females and there were no signs of dermal irritation at any observation during the study period. In an skin sensitization study in guinea pigs (Buehler method) the formulation did not elicit a sensitizing reaction. In acute eye irritation testing in albino rabbits (three), the formulation had a maximum average irritation score of 36.7 and was severely irritating and was assigned to Toxicity Category I. In an acute oral toxicity testing in rats, the acute oral LD50 was greater than 5000 mg/kg and was assigned to Toxicity Category IV. In an acute inhalation toxicity in rats, the LC50 was greater than 2.26 mg/L in males and females and was assigned to Toxicity Category IV.

These tests indicate that the formulation of Example 7 is not only effective as a biocide, but also is relatively safe and non-toxic.

### Example 8

A composition with 12% potassium ricinoleate, 2.8% ricinoleamidopropyl PG-dimonium chloride phosphate, 20% isopropyl alcohol, 10.9% terpineol, 10% PCMX, with the remainder deionized water was made. Without pH adjustment the pH was about 8.5 to 9.

### Example 9

A composition with about 10% mixture of an amine oxide and D-glucopyranoside, 10% disodium capryloampho dipropionate, 20% isopropyl alcohol, 10.9% terpineol, 10% PCMX, and the remainder deionized water was made. Without pH adjustment the pH was about 8.5.

### Example 10

A composition with about 32% of an ethoxylated amine, about 16% of polyoxy-1,2-ethanediyl,a,a-(iminodi-2,1-ethanediyl)bis(w-hydroxy-,N-(3-(C13 rich,C11-14-isoalkyl)oxy)propyl) derivatives, about 1.7% b-alanine, N-(2-Carboxyethyl)-N(3-(decyloxy)propyl)-, monosodium salt, 20% isopropyl alcohol, 10.9% terpineol, 10% PCMX, with the remainder deionized water was made. Without pH adjustment the pH was 8.5-9.

### Example 11

In this example, compositions were made with essential oils. As pre-mixes, for example, solutions of the essential oils as an oil mix (thyme, wintergreen, eucalyptus, and menthol), carvacrol, lemongrass, origanum, and thyme white were combined with terpineol and propylene glycol. The solutions were crystal clear with the exception of the thyme white mix which was slightly whitish. The solutions carried the characteristic fragrance of the essential oil used. These solutions could then be combined with the surfactant package of choice to produce a biocide concentrate and further diluted with water to produce solutions of the desired concentration. As an example, a concentrate composition was produced of about 10% of the oil mix, about 10.9% terpineol, about 20% propylene glycol, about 12% potassium ricinoleate, about 3% sodium dodecyl sulfate, with the remainder water. The pH of this solution was about 9-9.5 and the solution was clear. The addition of water is not necessary if a higher essential oil concentration is desired. This concentrate is dilutable with water to the desired essential oil concentration. For a composition containing the oil mix a use dilution was made of about 1000 ppm of the oil mix and the particle size measured. The particle size was about 54 nm with a zeta potential of about 60 mV and a conductivity of 0.4 mS/cm.

### Example 12

A concentrate composition was produced of about 10% of the carvacrol oil, about 10.9% terpineol, about 20% propylene glycol, about 12% potassium ricinoleate, about 3% sodium dodecyl sulfate, and the remainder water. The pH of this solution was about 9-9.5 and the solution was amber clear. The addition of water is not necessary if a higher essential oil solution concentration is desired. This concentrate is dilutable with water to the desired essential oil concentration.

### Example 13

A composition web site produced with about 32% of an ethoxylated amine (poly(5) oxyethylene isodecyloxypropylamine), about 16% of polyoxy-1,2-ethanediyl,a,a-(iminodi-2,1-ethanediyl)bis(w-hydroxy-,N-(3-(C13-rich,C11-14-isoalkyl)oxy)propyl)-, monosodium salt, 20% propylene glycol, 10.9% terpineol, 10% PCMX, and the remainder deionized water. Without pH adjustment the pH was 8.5.

### Example 14

A composition was made with about 8.8% deoiled lecithin (as from ADM of trade name Ultralec), 10% PCMX, 10.9% terpineol, 20% propylene glycol, with the remainder deionized water. Without pH adjustment the pH was about 6.

A 0.2% PCMX solution was made by dilution of the composition in deionized water. Without pH adjustment the pH was about 5-5.5.

### Example 15

A composition was made with about 24% of an ethoxylated amine (poly(5) oxyethylene isodecyloxypropylamine), about 12% of polyoxy-1,2-ethanediyl,a,a-(iminodi-2,1-ethanediyl)bis(w-hydroxy-,N(3-(C13-rich,C11-14-isoalkyl)oxy)propyl) derivatives, about 1.3% b-alanine, N-(2-carboxyethyl)-N(3-(decyloxy)propyl)-, monosodium salt, 20% propylene glycol, 10.9% terpineol, 10% PCMX, with the remainder deionized water. Without pH adjustment the pH was about 9. An about a 0.2% PCMX concentration of this composition was made by dilution with water and had a pH of about 8.5.

### Example 16

A composition was made with about 24% of an ethoxylated amine (poly(5) oxyethylene isodecyloxypropylamine), about 12% of polyoxy-1,2-ethanediyl,a,a-(iminodi-2,1-ethanediyl)bis(w-hydroxy-,N-(3-(C13-rich,C11-14 isoalkyl)oxy)propyl) derivatives, about 1.3% b-alanine, N-(2-carboxyethyl)-N(3-(decyloxy)propyl)-, monosodium salt, about 6% C9-C11 ethoxylated alcohols (with EO/alcohol ratio of 5.5-6.5), 20% propylene glycol, 10.9% terpineol, 10% PCMX, with the remainder deionized water. Without pH adjustment the pH was about 9. An about a 0.2% PCMX concentration of this composition was made by dilution with water and had a pH of about 8.5.

### Example 17

A composition was made with about 24% of an ethoxylated amine (poly(5) oxyethylene isodecyloxypropylamine), about 12% of polyoxy-1,2-ethanediyl,a,a-(iminodi-2,1-ethanediyl)bis(w-hydroxy-,N-(3-(C13-rich,C11-14-isoalkyl)oxy)propyl) derivatives, about 1.3% b-alanine, N-(2-carboxyethyl)-N(3-decyloxy)propyl)-monosodium salt, about 6% methyl-oxirane polymer with oxirane, 20% propylene glycol, 10.9% terpineol, 10% PCMX, with the remainder deionized water. Without pH adjustment the pH was about 8.5. An about a 0.2% PCMX concentration was made by dilution with water and had a pH of about 8.5.

### Example 18

A composition was made with about 23% of an ethoxylated amine (poly(5) oxyethylene isodecyloxypropylamine), about 11.5% of polyoxy-1,2-ethanediyl,a,a-(iminodi-2,1-ethanediyl)bis(w-hydroxy-,N-(3-(C13-rich,C11-14 isoalkyl)oxy) propyl) derivatives, about 1.2% b-alanine, N-(2-carboxyethyl)-N (3-(decyloxy)propyl)-, monosodium salt, about 5% C9-C11 ethoxylated alcohols (with EO/alcohol ratio of 5.5-6.5), 20% propylene glycol, 10.9% terpineol, 10% PCMX, with the remainder deionized water. Without pH adjustment the pH was about 9. An about a 0.2% PCMX concentration was made by dilution with water and had a pH of about 8.5.

### Example 19

A composition was made like Example 7, but with the addition of about 0.75% of the bisphosphonate, tetrasodium 1-hydroxyethylidene-1,1-diphosphonate. Without pH adjustment the pH was about 10.5.

### Example 20

A composition was made with about 24% of an ethoxylated amine (poly(5) oxyethylene isodecyloxypropylamine), about 12% of polyoxy-1,2-ethanediyl,a,a-(iminodi-2,1-ethanediyl)bis(w-hydroxy-,N-(3-(C13-rich,C11-14-isoalkyl)oxy)propyl) derivatives, about 1.3% b-alanine, N-(2-carboxyethyl)-N(3-(decyloxy)propyl)-, monosodium salt, about 6% C9-C11 ethoxylated alcohols (with EO/alcohol ratio of 5.5-6.5), 14.9% propylene glycol, 10.9% terpineol, 10% PCMX, with the remainder deionized water. Without pH adjustment the pH was about 9. An about a 0.2% PCMX concentration was made by dilution with water and had a pH of about 8.5.

### Example 21

A composition was made with about 40% 2-dodecoxyethanol, 20% propylene glycol, 10.9% terpineol, 10% PCMX, with the remainder deionized water. Without pH adjustment the pH was about 5.5 An about a 0.2% PCMX concentration was made by dilution with water and had a pH of about 5.

### Example 22

A composition was made with about 40% 2-dodecoxyethanol, 20% propylene glycol, 10.9% d-limonene, 10% PCMX, with the remainder deionized water. Without pH adjustment the pH was about 5.5. An about a 0.2% PCMX concentration was made by dilution with water and had a pH of about 5.

### Example 23

A composition was made with about 24% of an ethoxylated amine (poly (5) oxyethylene isodecyloxypropylamine), about 12% of polyoxy-1,2-ethanediyl,a,a-(iminodi-2,1-ethanediyl)bis(w-hydroxy-,N-(3-(C13-rich,C11-14-isoalkyl)oxy)propyl) derivatives, about 1.3% b-alanine, N-(2-carboxyethyl)-N(3-(decyloxy)propyl)-, monosodium salt, about 6% methyl-oxirane polymer with oxirane, 14.9% propylene glycol, 10.9% terpineol, 10% PCMX, with the remainder deionized water. Without pH adjustment the pH was about 9. An about a 0.2% PCMX concentration was made by dilution with water and had a pH of about 8.5.

### Example 24

A composition was made with about 30% 2-dodecoxyethanol, 6% methyl-oxirane polymer with oxirane, 20% propylene glycol, 10.9% terpineol, 10% PCMX, with the remainder deionized water. Without pH adjustment the pH was about 5-5.5.

### Example 25

A composition was made with about 35% 2-dodecoxyethanol, 5% methyl-oxirane polymer with oxirane, 20% propylene glycol, 10.9% terpineol, 10% PCMX, with the remainder deionized water. Without pH adjustment the pH was about 5-5.5.

### Example 26

A composition was made with about 23% of an ethoxylated amine (poly(5) oxyethylene isodecyloxypropylamine), about 11.5% of polyoxy-1,2-ethanediyl,a,a-(iminodi-2,1-ethanediyl)bis(w-hydroxy-,N-(3-(C13-rich,C11-14-isoalkyl)oxy)propyl) derivatives, about 1.2% b-alanine, N-(2-carboxyethyl)-N(3-(decyloxy)propyl)-, monosodium salt, about 5% C9-C11 ethoxylated alcohols (with EO/alcohol ratio of 7.9-8.9), 20% propylene glycol, 10.9% terpineol, 10% PCMX, with the remainder deionized water. Without pH adjustment the pH was about 9.5. An about a 0.2% PCMX concentration was made by dilution with water and had a pH of about 8-8.5.

### Example 27

A composition was made with about 40% 2-dodecoxyethanol, 15% propylene glycol, 10.9% terpineol, 10% PCMX, with the remainder deionized water. Without pH adjustment the pH was about 5.5.

### Example 28

A composition was made with about 40% 2-dodecoxyethanol, 20% propylene glycol, 5.45% d-limonene, 5.45% terpineol, 10% PCMX, with the remainder deionized water. Without pH adjustment the pH was about 5.5. An about a 0.2% PCMX concentration was made by dilution with water and had a pH of about 5.

### Example 29

A composition was made with about 35% 2-dodecoxyethanol, 5% methyl-oxirane polymer with oxirane, 20% propylene glycol, 5.45% d-limonene, 5.45% terpineol, 10% PCMX, with the remainder deionized water. Without pH adjustment the pH was about 5.5. An about a 0.2% PCMX concentration was made by dilution with water and had a pH of about 5.

### Example 30

A composition was made with about 35% 2-dodecoxyethanol, 5% of a mixture of castor oil polyethylene ether with PEG-12 cocoate and PEG-11 cocamide, 20% propylene glycol, 5.45% d-limonene, 5.45% terpineol, 10.1% PCMX, with the remainder deionized water. Without pH adjustment the pH was about 5.5.

### Example 31

A composition was made with about 27-35% sodium laureth sulfate (CAS No. 68585-34-2), 8-13% lauryl glucoside (D-glucopyranoside, C6-12-alkyl, oligomer)(CAS No. 113976-90-2), 8-13% ethanol (CAS No. 64-17-5), 2-5% sodium chloride, 17% PCMX (CAS No. 88-04-0), with the remainder deionized water. Without pH adjustment the pH was about 6-6.5.

### Example 32

A composition was made with about 30% sodium laureth sulfate, 10% decyl glucoside, 10% PCMX, 10.9% terpineol, 15% propylene glycol, with the remainder deionized water. Without pH adjustment the pH was about 8.5-9.

### Example 33

A composition was made with about 30% sodium laureth sulfate, 10% decyl glucoside, 10% PCMX, 10.9% terpineol, 15% propylene glycol, with the remainder deionized water.

### Example 34

A composition was made with about 30% sodium laureth sulfate, 10% lauryl glucoside, 10% PCMX, 10.9% terpineol, 15% propylene glycol, with the remainder deionized water. Without pH adjustment the pH was about 9-9.5.

### Example 35

A composition was made with about 28.5% sodium laureth sulfate, 9.5% decyl glucoside, 10% PCMX, 10.9% terpineol, 15% propylene glycol, with the remainder deionized water. Without pH adjustment the pH was about 9.5-10.

### Example 36

A composition was made with about 27% sodium laureth sulfate, 9% decyl glucoside, 10% PCMX, 10.9% terpineol, 15% propylene glycol, with the remainder deionized water. Without pH adjustment the pH was about 10.

### Example 37

A composition was made with about 24% sodium laureth sulfate, 8% decyl glucoside, 10% PCMX, 10.9% terpineol, 15% propylene glycol, with the remainder deionized water. Without pH adjustment the pH was about 10.

### Example 38

A composition was made with about 25% sodium laureth sulfate, 7% decyl glucoside, 10% PCMX, 10.9% terpineol, 15% propylene glycol, with the remainder deionized water. Without pH adjustment the pH was about 10.

### Example 39

A composition was made with about 24% sodium laureth sulfate, 8% decyl glucoside, 10% PCMX, 10.9% terpineol, 15% propylene glycol, with the remainder deionized water. Without pH adjustment the pH was about 10.

### Example 40

A composition was made with about 30% sodium laureth sulfate, 10% decyl glucoside, 10% PCMX, 10.9% terpineol, 15% propylene glycol, with the remainder deionized water. Without pH adjustment the pH was about 10.

### Example 41

A composition with about 30% decyl glucoside, 10% PCMX, 10.9% terpineol, 15% propylene glycol, with the remainder deionized water. Without pH adjustment the pH was about 9.5-10.

### Example 42

A composition was made with about 30% sodium laureth sulfate, 10% decyl glucoside, 10% PCMX, 10.9% terpineol, 15% propylene glycol, with the remainder deionized water. Without pH adjustment the pH was about 5.5.

### Example 43

A composition was made with about 30% sodium laureth sulfate, 10% decyl glucoside, 10% PCMX, 10.9% terpineol, 15% propylene glycol, with the remainder deionized water. Without pH adjustment, the pH was about 10-10.5.

### Example 44

A composition was made with about 30% sodium laureth sulfate, 10% decyl glucoside, 10% PCMX, 10.9% terpineol, 15% propylene glycol, with the remainder deionized water. Without pH adjustment, the pH was about 10-10.5.

### Example 45

A composition was made with about 30% sodium laureth sulfate, 10% decyl glucoside, 10% PCMX, 10.9% terpineol, 15% propylene glycol, with the remainder deionized water.

### Example 46

A composition was made with about 25% sodium laureth sulfate, 10% decyl glucoside, 10% PCMX, 10.9% terpineol, 20% propylene glycol, with the remainder deionized water. Without pH adjustment, the pH was about 10.

### Example 47

A composition was made with about 25% sodium laureth sulfate, 10% decyl glucoside, 10% PCMX, 10.9% terpineol, 20% propylene glycol, with the remainder deionized water. Without pH adjustment, the pH was about 10.

### Example 48

A composition was made with about 30% sodium laureth sulfate, 10% decyl glucoside, 10% PCMX, 10.9% terpineol, 15% propylene glycol, with the remainder deionized water. Without pH adjustment, the pH was about 10.

### Example 49

A composition was made with about 30% sodium laureth sulfate, 10% decyl glucoside, 10% PCMX, 10.9% terpineol, 15% propylene glycol, with the remainder deionized water. Without pH adjustment, the pH was about 10.

### Example 50

A composition was made with about 29% sodium laureth sulfate, about 6.5% D-glucopyranose, about 6.5% cocamidopropyl betaine, about 2.9% sodium chloride, 10% PCMX, 10.9% terpineol, 15% propylene glycol, with the remainder deionized water. Without pH adjustment, the pH was about 5.5.

### Example 51

A composition was made with about 20% sodium laureth sulfate, about 4.5% D-glucopyranose, about 4.5% cocamidopropyl betaine, about 2% sodium chloride, 10% PCMX, 10.9% terpineol, 15% propylene glycol, with the remainder deonized water. Without pH adjustment, the pH was about 5.5.

### Example 52

A composition was made with about 25% sodium laureth sulfate, about 5.5% D-glucopyranose, about 5.5% cocamidopropyl betaine, about 2.5% sodium chloride, 10% PCMX, 10.9% terpineol, 15% propylene glycol, with the remainder deionized water. Without pH adjustment, the pH was about 5.5.

### Example 53

A composition was made with about 30% sodium laureth sulfate, 8% decyl glucoside, 10% PCMX, 10.9% terpineol, 15% propylene glycol, with the remainder deionized water. Without pH adjustment, the pH was about 9.

### Example 54

A composition was made with about 30% sodium laureth sulfate, 8% decyl glucoside, 10% PCMX, 10.9% terpineol, 15% propylene glycol, with the remainder deionized water. Without pH adjustment, the pH was about 9.

### Example 55

A composition was made with about 28% sodium laureth sulfate, 10% decyl glucoside, 10% PCMX, 10.9% terpineol, 15% propylene glycol, with the remainder deionized water. Without pH adjustment, the pH was about 10.

### Example 56

A composition was made with about 28% sodium laureth sulfate, 12% decyl glucoside, 10% PCMX, 10.9% terpineol, 15% propylene glycol, with no added deionized water, as some of the ingredients contained water. Without pH adjustment, the pH was about 10.

### Example 57

A composition was made with about 28% sodium laureth sulfate, 10% decyl glucoside, 10% PCMX, 10.9% terpineol, 18.9% propylene glycol, with no added deionized water, as some of the ingredients contained water. Without pH adjustment, the pH was about 10.

### Example 58

A composition was made with about 28% sodium laureth sulfate, 11% decyl glucoside, 0.66% alkyloxy propylamine dipropionate, 10% PCMX, 10.9% terpineol, 15% propylene glycol, with the remainder deionized water. Without pH adjustment, the pH was about 10.

### Example 59

A composition was made with about 30% sodium laureth sulfate, 10% decyl glucoside, 10% PCMX, 10.9% terpineol, 16% propylene glycol, with no added deionized water, as some of the ingredients contained water. Without pH adjustment, the pH was about 10.

### Example 60

A composition was made with about 30% sodium laureth sulfate, 10% decyl glucoside, 10.25% PCMX, 10.9% terpineol, 15.7% propylene glycol, with no added deionized water, as some of the ingredients contained water. Without pH adjustment, the pH was about 10.

### Example 61

A composition was made with about 30.4% sodium laureth sulfate, 10% glycoside, 10.25% PCMX, 10.9% terpineol, 15.7% propylene glycol, with no added deionized water, as some of the ingredients contained water. Without pH adjustment, the pH was about 10.

### Example 62

A composition was made with about 30.43% sodium laureth sulfate, 10% glucoside, 10.25% PCMX, 10.9% terpineol, 15.7% propylene glycol, with no added deionized water, as some of the ingredients contained water. Without pH adjustment the pH was about 10. With pH adjusted with concentrated HCl, the pH was 8.59.

### Example 63

A composition was made with about 30% sodium laureth sulfate, 10% glucoside, 10.25% PCMX, 10.9% terpineol, 15.7% propylene glycol, with no added deionized water, as some of the ingredients contained water. Without pH adjustment the pH was about 10. With pH adjusted with concentrated HCl, the pH was 8.55.

In an independent laboratory, microbiological testing was conducted with the formulation of Example 63 at about 200 ppm PCMX in deionized and in a 2.5% sodium chloride solutions at room temperature (23±2 C). The organisms studied were Bacillus cereus ATCC#14579, Pseudomonas fluorescens ATCC#13525, and Aspergillus niger spores ATCC#9642. The contact times for testing were less than one minute, 1 and 3 hours. For the vegetative bacteria Bacillus cerus and Pseudomonas fluorescens at all times and for both organisms the number of organisms remaining were <1 organism (no growth). The log reductions were greater than 4 logs demonstrating significant antibacterial activity. For the A. niger spores tested with 2.5% sodium chloride solution the reductions were 58.75% and 77.78% at 3 hours respectively.

On formulation of Example 63 independent microbiological testing was conducted at about 200 ppm PCMX in 2.5% sodium chloride solutions at room temperature (20 C) per ASTM E2315-03 at 1 hour contact time. The organism studied was Desulphovibrio desulfuricans ATCC#29577. At an initial concentration of 2.0×10⁷ cfu/ml the reduction at 1 hour was 92.5% (1.50×10⁶) or a reduction of 18,500,000 organisms per ml.

### Example 64

A composition was made with about 26.2% sodium C14-C17 alkyl sec. sulfonate, 10% glucoside, 10.25% PCMX, 10.9% terpineol, 15.7% propylene glycol, with no added deionized water, as some of the ingredients contained water. Without pH adjustment, the pH was about 10.

### Example 65

A composition was made with about 30% sodium laureth sulfate, 10% decyl glucoside, 10.25% PCMX, 10.9% pine oil (Unipine 85), 15.7% propylene glycol with no added deionized water as some of the ingredients contained water. Without pH adjustment the pH was about 10.

### Example 66

A composition was made with 12% potassium ricinoleate, 3% sodium dodecyl sulfate, 20% propylene glycol, 10.9% pine oil (Unipine 85), and 10.2% PCMX with the remainder deionized water. Without pH adjustment the pH was 9-9.5.

### Example 67

A composition with about 28.8% sodium laureth sulfate, 9.6% decyl glucoside, 11% PCMX, 11.64% pine oil (Unipine 85), 16.75% propylene glycol with no added deionized water, as some of the ingredients contained water. Without pH adjustment the pH was about 9.5.

### Example 68

A composition was made with about 30.0% sodium laureth sulfate, 10.0% decyl glucoside, 10.25% PCMX, 10.9% pine oil (Unitene LE), 15.7% propylene glycol with no added deionized water, as some of the ingredients contained water. This solution formed a gel.

### Example 69

A composition was made with about 28.0% sodium laureth sulfate, 9.3% decyl glucoside, 10.2% PCMX, 10.9% pine oil (Unitene LE), 20.0% propylene glycol with no added deionized water, as some of the ingredients contained water.

### Example 70

A composition was made with about 25.2% sodium laureth sulfate, 8.4% decyl glucoside, 10.2% PCMX, 10.9% pine oil (Unitene LE), 20.0% propylene glycol with 5.9% added deionized water.

### Example 71

A composition was made with about 26.6% sodium laureth sulfate, 8.9% decyl glucoside, 10.2% PCMX, 10.9% pine oil (Unitene LF), 22.95% propylene glycol with no added deionized water, as some of the ingredients contained water. Without pH adjustment the pH was about 9.

### Example 72

A composition was made with about 30.0% potassium ricinoleate, 3.0% sodium dodecyl sulfate, 10.2 PCMX, 10.9% pine oil (Unitene LF), 20.0% propylene glycol with 15.81% added deionized water. Without pH adjustment the pH was about 9.5.

### Example 73

A composition was made with about 28.3% sodium laureth sulfate, 9.5% decyl glucoside, 10.24% PCMX, 30.0% propylene glycol with no added deionized water, as some of the ingredients contained water. Without pH adjustment the pH was about 8.5-9.

### Example 74

A composition was made with about 30.0% potassium ricinoleate, 3.0% sodium dodecyl sulfate, 10.25% PCMX, 30.0% propylene glycol with 16.63% added deionized water. Without pH adjustment the pH was about 8.5-9.

### Example 75

A composition was made with about 28.0% sodium laureth sulfate, 9.3% decyl glucoside, 10.2% PCMX, 10.9% d-limonene, 20.0% propylene glycol with no added deionized water, as some of the ingredients contained water. With no pH adjustment pH was about 8-8.5.

### Example 76

A composition was made with about 28.0% sodium laureth sulfate, 9.3% decyl glucoside, 10.2% PCMX, 10.9% Terpene Special (IFF, includes hydrocarbons, terpene processing by-products, terpene hydrocarbons, by products; alcohols, C10-terpenoidal; benzene, 1-methoxy-4-(1E)-1-propen-1-yl-; terpenes and terpenoids, turpentine-oil, myrcene fraction, hydroxyl, acetates), 20.0% propylene glycol with no added deionized water, as some of the ingredients contained water. With no pH adjustment pH was about 9.

### Example 77

A composition was made with about 28.0% sodium laureth sulfate, 9.3% decyl glucoside, 10.2% PCMX, 10.9% Unitene D (IFF, hydrocarbons, terpene processing by-products, terpene hydrocarbons, by product), 20.0% propylene glycol with no added deionized water, as some of the ingredients contained water. With no pH adjustment pH was about 9-10.

### Example 78

A composition was made with about 28.0% sodium laureth sulfate, 9.3% decyl glucoside, 10.2% PCMX, 5.9% Unitene D (IFF, hydrocarbons, terpene processing by-products, terpene hydrocarbons, by product), 25.0% propylene glycol with no added deionized water, as some of the ingredients contained water. With no pH adjustment pH was about 8.5-9.

The following Examples are presented to evaluate various biocide formulations produced in Examples 1-78 above in various waters, including several waters obtained from actual well drilling sites and manufactured waters with various salt levels. The manufactured waters were produced by weighing in specific chemistries and diluting with deionized water. Various volumes/weights of the water were placed in laboratory glassware and mixed gently with a magnetic stirrer at ambient temperature. A volume/weight of the specific formulations was added drop wise to the stirring water and observations of the solution conditions made. Specific attention was made to observe any oil-like separation, precipitate formed, and cloudiness or opaqueness in the solution. Observations were typically made over hours and days without the solution being continually mixed. Specific materials or methods related to individual tests are described in the Examples that follow.

### Example 79

Twelve different field water samples (A-L) were obtained from actual drilling well sites. The twelve different waters and their properties are shown in Table 1 below.

TABLE 1
Field Water

| Chemistry | A | B | C | D | E | F | G | H | I |
|---|---|---|---|---|---|---|---|---|---|
| pH | 5.93 | 7.06 | 6.70 | 7.25 | 6.88 | 7.14 | 7.19 | 6.23 | 5.71 |
| Specific | 1.003 | 1.033 | 1.003 | 1.033 | 1.039 | 1.033 | 1.033 | 1.003 | 1.003 |
| gravity | | | | | | | | | |
| H₂S, mg/L | 0 | 0 | 0 | 0 | 0 | 1 | 7.5 | 0 | 0 |
| Calcium++, | 16 | 363 | 17 | 765 | 675 | 864 | 669 | 14 | 10 |
| mg/L | | | | | | | | | |
| Magnesium++, | 1205 | 6340 | 475 | 1965 | 2262 | 2634 | 4453 | 1692 | 1694 |
| mg/L | | | | | | | | | |
| Sodium+, | 0 | 2061 | 382 | 10295 | 16204 | 13952 | 5525 | 0 | 0 |
| mg/L | | | | | | | | | |
| Barium++, | 0 | 1 | 0 | 2 | 3 | 3 | 3 | 0 | 0 |
| mg/L | | | | | | | | | |
| Bicarbonate−, | 24 | 2257 | 6 | 1653 | 1342 | 1220 | 1189 | 24 | 12 |
| mg/L | | | | | | | | | |
| Sulfate−−, | 6 | 0 | 0 | 0 | 0 | 24 | 0 | 2 | 0 |
| mg/L | | | | | | | | | |
| Chloride−, | 3524 | 21000 | 2000 | 22000 | 32000 | 30000 | 22000 | 4944 | 4951 |
| mg/L | | | | | | | | | |
| Dissolved | 4775 | 32022 | 2880 | 36680 | 52486 | 48697 | 33839 | 6677 | 6668 |
| Solids, mg/L | | | | | | | | | |
| Total iron, | 1.22 | 1.81 | 1.22 | 1.59 | 2.53 | 11.30 | 3.04 | 0.29 | 2.56 |
| mg/L | | | | | | | | | |
| Total hardness, | 5000 | 27000 | 2000 | 10000 | 11000 | 13000 | 20000 | 7000 | 7000 |
| mg/L | | | | | | | | | |
| Resistivity, | 0.925 | 0.225 | 2.000 | 0.222 | 0.174 | 0.183 | 0.222 | 0.685 | 0.684 |
| Ohm-m | | | | | | | | | |

| Chemistry | J | K | L |
|---|---|---|---|
| pH | 7.38 | 6.80 | 7.82 |
| Specific | 1.143 | 1.052 | 1.027 |
| gravity | | | |
| H₂S, mg/L | 0 | NA | <0.5 |
| Calcium++, | 4449 | 762 | 68 |
| mg/L | | | |
| Magnesium++, | 596 | 68 | 18 |
| mg/L | | | |
| Sodium+, | 59640 | 9547 | 105 |
| mg/L | | | |
| Barium++, | 80 | 0 | 2 |
| mg/L | | | |
| Bicarbonate−, | 0 | 0 | 0 |
| mg/L | | | |
| Sulfate−−, | 140 | 640 | 170 |
| mg/L | | | |
| Chloride−, | 101477 | 15796 | 210 |
| mg/L | | | |
| Dissolved | 166382 | 26813 | 573 |
| Solids, mg/L | | | |
| Total iron, | 42.00 | 24.00 | 0.02 |
| mg/L | | | |
| Total hardness, | 13562 | 2182 | 245 |
| mg/L | | | |
| Resistivity, | 0.024 | 0.268 | 2.699 |
| Ohm-m | | | |

Overall means and range of the properties of the twelve field waters are shown in Table 2 below.

TABLE 2

| Chemistry | Mean, n = 12 | Range, n = 12 |
|---|---|---|
| PH | 6.84 | 5.71-7.82 |
| Specific | 1.034 | 1.003-1.143 |
| gravity | | |
| H₂S, mg/L | 0.78 | 0-7.5 |
| Calcium++, | 723 | 10-4449 |
| mg/L | | |
| Magnesium++, | 1950 | 18-6340 |
| mg/L | | |
| Sodium+, | 9809 | 0-59640 |
| mg/L | | |
| Barium++, | 7.8 | 0-80 |
| mg/L | | |
| Bicarbonate−, | 644 | 0-2257 |
| mg/L | | |
| Sulfate−−, | 82 | 0-640 |
| mg/L | | |
| Chloride−, | 21659 | 210-101477 |
| mg/L | | |
| Dissolved | 34874 | 573-166382 |
| Solids, mg/L | | |
| Total iron, | 7.63 | 0.02-42.00 |
| mg/L | | |
| Total hardness, | 9832 | 245-27000 |
| mg/L | | |
| Resistivity, | 0.693 | 0.024-2.699 |
| Ohm-m | | |

The field waters were evaluated with biocide formulations having PCMX as the biocide, propylene glycol as the solubilizing agent, and varying surfactants. PCMX concentrations at 100 ppm and 500 ppm were evaluated. The observations are shown in Table 3 below.

TABLE 3

| Water/ | |
|---|---|
| Formu- | |
| lation | |
| Exam- | |
| ple No. | Observations |
| E/7 | Very small amount of fine precipitate formed, |
| 100 ppm PCMX | no oily film, opaque |
| J/16 | Initially good dispersion with no ppt., no oil |
| 500 ppm PCMX | At 24 hours-soln. hazy, oil noted |
| K/16 | Initially cloudy, no oil |
| 500 ppm PCMX | At 24 hours- ppt. on bottom, oil, some surface |
| | particulate |
| L/16 | Initially soln. cloudy, no ppt., no oil |
| 500 ppm PCMX | At 24 hours-some cloudiness, ppt. on bottom, |
| | oil, soln. got more opaque on mixing |
| J/17 | Initially no noticeable change |
| 500 ppm PCMX | At 24 hours-reddish mass on top, oil on surface (?) |
| K/17 | Initially hazy, ppt. |
| 500 ppm PCMX | At 24 hours-debris on surface, ppt. liquid(?) |
| | on bottom |
| L/17 | Initially soln. hazy, fine ppt. formed |
| 500 ppm PCMX | At 24 hours soln. cloudy, ppt. on bottom, no |
| | oil, soln. got more opaque on mixing |
| J/13 | Initially soln. hazy, no ppt., no oil |
| 500 ppm PCMX | At 24 hours-reddish mass on surface, oil on |
| | surface |
| K/13 | Initially soln. hazy, no ppt., no oil |
| 500 ppm PCMX | At 24 hours-solid debris on top, liquid ppt. on |
| | bottom, no oil |
| L/13 | Initially soln. hazy, no ppt., no oil |
| 500 ppm PCMX | At 24 hours-fine liquid on bottom, no oil, soln. |
| | clear but got more opaque on mixing |
| J/21 | Initially may have gotten more cloudy, oil |
| 500 ppm PCMX | At 72 hours reddish ppt. on surface and bottom, |
| | no oil |
| K/21 | Initially cloudy, no oil |
| 500 ppm PCMX | At 72 hours soln. not clear, some ppt., no oil |
| L/21 | Initially soln. opaque |
| 500 ppm PCMX | At 72 hours soln. not clear, no oil |
| J/22 | Initially hazy, oil drops |
| 500 ppm PCMX | At 24 hours brownish mass, oil on top, with |
| | mixing soln. gets more opaque |
| | At 96 hours reddish ppt. on surface, perhaps |
| | some minor oil film in spots |
| K/22 | Initially hazy, no oil |
| 500 ppm PCMX | At 24 hours-whittish ppt., no oil |
| | At 96 hours soln. not clear, some ppt., no oil |
| L/22 | Initially hazy, no ppt., no oil |
| 500 ppm PCMX | At 24 hours white cloudy ppt., no oil |
| | At 96 hours-white cloudy ppt., no oil |
| J/23 | Initially soln. clouded, oil |
| 500 ppm PCMX | At 72 hours reddish ppt. near top, some ppt. on |
| | bottom, some oil on top |
| K/23 | Initially brownish soln. got more cloudy, no oil |
| 500 ppm PCMX | At 72 hours soln. brownish, some ppt. on bottom, no |
| | oil |
| L/23 | Initially clear soln. got cloudy, no oil |
| 500 ppm PCMX | At 72 hours soln. clear with oily material on bottom |
| J/7 | Initially did not observe a change, oily drops on |
| 500 ppm PCMX | edge |
| | At 24 hours reddish ppt. on bottom, some surface |
| | waxy material, |
| | At 96 hours waxy ppt. on sides, reddish ppt. on bottom |
| J/25 | Initially soln. remained reddish cloudy, no oil |
| 500 ppm PCMX | At 24 hours reddish ppt. on surface and bottom, |
| | “oil” like material on edges, with mixing |
| | material appears to mix in |
| | At 96 hours reddish ppt. mostly on surface, slight |
| | “oil” film on surface |
| E/9 | with formulation addition, solution got cloudy, |
| 100 ppm PCMX | fine ppt. formed |

### Example 80

This Example is presented to evaluate select biocide formulations shown in Examples 1-78 above in deionized water with 6% potassium chloride and 0.5% calcium chloride added as well as in 2 field waters (J and L) at a biocide concentration of 500 ppm PCMX. From prior testing with varying salt compositions, the 6% potassium and 0.5% calcium chloride was recognized to be a “worst” case water in terms of demonstrating instability (precipitates forming or oil-like materials separating) of the biocide formulations. For emulsion formulations in general, salting studies have been demonstrated to provide comparative way of comparing formulations for stability. The deionized (DI) water used was produced in a laboratory Barnstead Nanopure Diamond/Diamond RO system. The DI water had a resistivity of about 18.2 Mohm-cm. The solution was prepared by weighing in the salts and water to two decimal places. The pH of the resulting solution was 5.5 as tested using pH-indicator strips. All reusable glassware was cleaned and dried before use. Solutions were volumetrically measured using a 25 ml sterile serological pipette (for the salt water) and a 1 ml sterile serological pipette for the biocide formulations. The salt water was added to a glass beaker and gently mixed with a magnetic stirrer. The biocide formulation was then added. In this study, 100 ml of the salt water was used along with 0.5 ml of the biocide formulation, thus giving a PCMX concentration of about 500 ppm, except in one sample where 340 ppm was used. All solutions had 6% potassium chloride and 0.5% calcium chloride unless otherwise noted. In some formulations the tests were repeated on different days to evaluate repeatability of the results.

Observations were made initially-1 and at various times. The observations for the various formulations and water used are shown below in Table 4.

TABLE 4

| Water/ | |
|---|---|
| Formu- | |
| lation | |
| Exam- | |
| ple No. | Observations |
| DI/16 | 1-cloudy, no oil |
| | At 24 hours-cloudy, oil, with mixing soln. got opaque |
| DI/17 | 1-hazy, ppt. or oil drops (?) |
| | At 24 hours-cloudy, oil on surface |
| DI/13 | 1-hazy, no ppt., no oil |
| DI/21 | 1-opaque |
| | At 72 hours soln. clear with some oil film on surface |
| DI/22 | 1-hazy, oil |
| | At 24 hours-cloud in soln., no oil, with mixing soln. |
| | got opaque |
| | At 96 hours-whitish ppt. throughout, no oil |
| DI/23 | 1-opague, oil film |
| | At 72 hours soln. not clear, oil on surface/edges |
| Field | 1-oil separation, reddish ppt. |
| Water | at 24 hours-reddish ppt. waxy material on surface |
| J/7 | at 96 hours-waxy ppt. on sides, reddish ppt. |
| Field | 1-reddish ppt. on bottom |
| Water | at 24 hours-reddish ppt. on bottom and surface, oil- |
| J/25 | like material on edge that mixed in |
| | at 96 hours-reddish ppt. on surface, oily film on surface |
| Field | 1-soln. cloudy, fine ppt. (?), no oil |
| Water | at 2.5 hours-soln. opaque, no ppt., no oil, no change |
| L/25 | with stirring |
| | at 19 hours- soln. opaque, no ppt., no oil, no change |
| | with stirring |
| | at 90 hours- soln. opaque, no ppt., no oil, no change |
| | with stirring |
| Field | 1-soln. cloudy, no oil |
| Water | at 2.5 hours-soln. opaque, no ppt., no oil, no change |
| L/27 | with stirring |
| | at 19 hours- soln. opaque, no ppt., no oil, no change |
| | with stirring |
| | at 90 hours- soln. opaque, no ppt., no oil, no change |
| | with stirring |
| DI/7 | 1-waxy ppt. formed, soln. clear, |
| | at 24 hours-no change from above |
| | at 96 hours-no further change |
| DI with | 1-soln. got cloudy, ppt. formed, no oil on surface, oil |
| 6% | like drops on bottom |
| KCl/7 | at 24 hours-thin ppt. film on surface and oily like |
| | film on bottom, soln. got hazy with mixing |
| | at 96 hours-no change |
| DI water | 1-soln crystal clear |
| with no | at 24 hours-sl. whitish tint with some surface material |
| salt/7 | that mixed in with stirring |
| (control) | |
| DI/24 | 1-scum on surface, no ppt., no oil |
| | at 24 hours-scum (oil(?)) on edge, hazy soln. |
| | at 72 hours oil on edge |
| DI/25 | 1-soln. got cloudy |
| | at several hours-oil(? or formulation separation) |
| | drops noted |
| | at 24 hours-oil on surface edge, whitish hazy cloud |
| | at 72 hours-few oil drops on edge |
| | at 144 hours-soln. hazy, one 1 mm oil drop in center |
| | at 168 hours-soln. hazy, no oil separation |
| | at 192 hours-soln. hazy, no oil |
| | at 216 hours, soln. hazy, no oil |
| | 1-soln. hazy, no ppt., oil drops on edge |
| | at 19 hours-soln. clear w film on ¼ surface, no ppt., |
| | oil drops on edge, w stirring soln. got opaque |
| | at 89 hours-soln. clear, no ppt., surface material, |
| | possibly oil, w stirring soln. got opaque |
| | 1-soln. opaque, no ppt., no oil |
| | at 1 hour-soln. hazy, no ppt., fine oil drops, in center |
| | and on edge, w stirring soln. gets more hazy |
| | at 3 hours-soln. hazy, no ppt., oil drops on edge and |
| | center, some material suspended, w stirring soln. got |
| | more cloudy |
| | at 67 hours-soln. clear, no ppt., soln. drops on edge, |
| | some material, w stirring soln. got opaque |
| DI/26 | 1-soln. hazy, scum on surface |
| | at 24 hours-oil drops on edge, |
| | at 48 hours-oil drops/film on edge |
| DI/27 | 1-soln. opaque, fine(?) ppt., no oil, material near |
| | edge that mixes in |
| | at 19 hours-soln. clear, no ppt., no oil, material on |
| | surface edge that w stirring mixes in and soln. becomes |
| | opaque |
| | at 89 hours-soln. clear, no ppt., no oil, material on |
| | surface edge that with stirring mixes in and soln. becomes |
| | opaque |
| | 1-soln. opaque, no ppt., no oil |
| | at 1 hour-soln. hazy, no ppt., surface material |
| | at 3 hours-soln. clear, no ppt., no oil, surface material |
| | on edge, soln. got more cloudy with stirring |
| | at 67 hours-soln. clear, no ppt., no oil, clear material |
| | on surface that mixes in and soln. gets more opaque |
| | 1-soln. opaque, no ppt., no oil |
| | at 1 hour-soln. hazy, no ppt., no oil, surface material, |
| | opaque on mixing |
| | at 3.5 hours-soln. hazy, no ppt., no oil, surface material, |
| | opaque on mixing |
| | at 20 hours-soln. hazy, no ppt., no oil, surface material, |
| | opaque on mixing |
| | at 45 hours-soln. hazy, no ppt., no oil, surface material, |
| | opaque on mixing |
| | 1-soln. opaque, no ppt., no oil |
| | at 2 hours-soln. clear, no ppt., no oil(?), opaque |
| | with mixing |
| | at 18.5 hours-soln. clear, no ppt., no oil, surface |
| | material, opaque with mixing |
| | at 45.5 hours-soln. clear, no ppt., no oil, opaque with |
| | mixing |
| | 1-soln. opaque, no ppt., no oil |
| | at 2 hours-soln. clear, no ppt., materials on edge, opaque |
| | with mixing |
| | at 18 hours-soln. clear, no ppt., no oil, clear material on |
| | edge, opaque with mixing |
| | at 27 hours-soln. clear, no ppt, no oil, clear material on |
| | surface/edge, opaque with mixing |
| | at 42 hours-soln. clear to hazy, no ppt., no oil, material on |
| | edge, opaque with mixing |
| | at 114 hours-soln. clear, no ppt., no oil, material on edge, |
| | opaque w mixing |
| | 1-soln. hazy, no ppt., no oil |
| | at 3 hours-soln. clear w surface material, no ppt., no oil, |
| | w mixing soln. hazy |
| | at 68 hours-soln. clear, surface material, no ppt., no oil, |
| | w mixing soln. hazy |
| | at 92 hours-soln. clear, no ppt., no oil, surface material, |
| | w mixing soln. hazy |
| DI/28 | 1-soln. opaque, no ppt., no oil |
| | at 1 hour-soln. hazy, no ppt., some surface material (oil or |
| | soluble?), soln. gets more hazy with stirring |
| | at 3 hours-soln. clear, some fine particles on bottom, |
| | surface material that mixes in with stirring |
| | at 67 hours-soln. clear, “fine” ppt., no oil, surface |
| | material that w stirring makes soln. opaque |
| | 1-soln. opaque, no ppt., no oil |
| | at 2 hours-soln. clear, no ppt., no oil(?), opaque with mixing |
| | at 18.5 hours-soln. clear, no ppt., no oil, surface material, |
| | opaque with mixing |
| | at 45.5 hours-soln. clear, no ppt., no oil, cloudy surface |
| | material, opaque with mixing |
| DI/29 | 1-soln. opaque, no ppt., no oil |
| | at 1 hour-soln. Opaque, no ppt., no oil, material on surface |
| | that makes soln. more hazy with mixing in |
| | at 3 hours-soln. opaque, no ppt., no oil, some surface material |
| | but no soln. change on mixing |
| | at 67 hours-soln. clear, no ppt., no oil, material on surface |
| | that w mixing made soln. opaque |
| | 1-soln. opaque, no ppt., no oil |
| | at 2 hours-soln. hazy/opaque, no ppt., oil like drops on edge, |
| | surface material, more opaque with mixing |
| | at 18.5 hours-soln. hazy, no ppt., oil like material on edge, |
| | surface material, opaque with mixing |
| | at 45.5 hours-soln. clear, no ppt., no oil, some cloudy |
| | surface material, opaque with mixing |
| DI/30 | 1-soln. opaque, no ppt., no oil |
| | at 2 hours-soln. hazy, no ppt., oil like drops on edge, |
| | surface material, opaque with mixing |
| | at 18.5 hours-soln. clear, no ppt., no oil(?), surface |
| | material, opaque with mixing |
| | at 45.5 hours-soln. clear, no ppt., no oil, some cloudy |
| | surface material, opaque with mixing |
| DI/31 | 1-soln. hazy, oily like ppt., no surface oil |
| | at 3 hours-soln. cloudy in sections with material and |
| | ppt., no oil, w mixing soln. hazy |
| | at 68 hours-soln. hazy, oily like ppt. material |
| | undissolved, w mixing soln. hazy |
| | at 92 hours-soln. hazy, ppt., no oil, w mixing soln. hazy |
| | At about 340 ppm PCMX |
| | 1-soln. hazy, oily like ppt., no surface oil |
| | at 3 hours-soln. clear, material clouds reaching to |
| | bottom, material ppt.(?), w mixing soln. hazy |
| | at 68 hours-soln. hazy, sedimented material, no surface |
| | oil, w mixing soln. hazy |
| | at 92 hours-soln. hazy, ppt., no oil, w mixing soln. hazy |
| DI/32 | 1-soln. cloudy/opaque, no ppt., no oil |
| | at 2 hours-soln. opaque, no ppt., no oil, no change w |
| | mixing |
| | at 18 hours-soln. opaque, fine ppt., no oil, no change |
| | w mixing |
| | at 26 hours-soln. opaque, no ppt. (?), no oil, no |
| | change w gentle mixing |
| | at 42 hours-soln. opaque, fine sediment/ppt., no oil, |
| | no change w gentle mixing |
| | at 140 hours-soln. opaque, fine sediment, no oil, |
| | no change w gentle mixing, fine sediment mixed in |
| DI/34 | 1-soln. cloudy/opaque, ppt. (?), no oil |
| | at 2 hours-soln. opaque, no ppt., no oil, w mixing |
| | no noticeable change |
| | at 18 hours-soln. opaque, fine ppt., no oil, no change |
| | on mixing w fine ppt. mixed in |
| | at 26 hours-soln. opaque, very fine sediment, no oil, |
| | no change w gentle mixing |
| | at 42 hours-soln. opaque, fine sediment, no oil, w |
| | gentle mixing no change |
| | at 140 hours-soln. opaque, fine sediment, no oil, w |
| | gentle mixing no change, fine sediment mixed in |
| DI/60 | 1-soln. opaque, no ppt., no oil |
| | At 3 hours-soln. opaque/translucent, no ppt., some |
| | suspended material noted, no oil, w mixing soln. |
| | opaque/translucent |
| | At 23 hours- soln. opaque/translucent, fine sediment, |
| | no oil, w mixing soln. opaque/translucent, sediment |
| | mixed in |
| | At 48 hours- soln. opaque/translucent, fine sediment, |
| | no oil, w mixing soln. opaque/translucent, sediment |
| | mixed in |
| | At 70 hours- soln. opaque/translucent, fine sediment, |
| | no oil, w mixing soln. opaque/translucent, sediment |
| | mixed in |
| | At 144 hours- soln. opaque/translucent, fine sediment, |
| | no oil, w mixing soln. opaque/translucent, sediment |
| | mixed in |
| DI/73 | 1-soln. opaque, no ppt., no oil |
| | At 1.5 hours-soln. opaque, no ppt., no oil, w mixing |
| | no change |
| | At 22 hours-soln. opaque, no ppt., no oil, w mixing |
| | no change |
| | At 43 hours-soln. opaque, no ppt., no oil, w mixing |
| | no change |
| | At 116 hours-soln. opaque, no ppt., no oil, w mixing |
| | no change |
| | Refrigerated solution. Through 3 days no sedimented |
| | material, no crystalline, no oil, with mixing soln. |
| | opaque. After refrigeration and at room temperature |
| | overnight soln. opaque, no ppt., no oil |

ppt. = precipitate; soln. = solution; sl. = slightly

The results show that the water type makes a difference. Significant differences were seen with DI water with no salt (shown as control in the Table 4 above) and when DI water with 6% potassium chloride and 0.5% calcium chloride was used. The high salt water is much more likely to cause instability of some of the solutions. When the appearance of oil is observed, with mixing the oil may re-absorb suggesting the need for mixing. Density differences may also account for this. The observations and the effects seen relate to the degree and amount of mixing. The formulations are emulsions and their integration into the varying water types relate to the degree and amount of mixing.

Separation of material (not oily) occurs in some cases and relates to the time between stiffing or mixing even though this stirring/mixing was considered very gentle and minimal. When surface material is present it mixes in well with very gentle stirring.

### Example 81

This Example is presented to evaluate select biocide formulations, at a concentration of 200 ppm PCMX, shown in Examples 1-78 above in deionized water with 6% potassium chloride and 0.5% calcium chloride. Testing at about 200 ppm PCMX was carried out, and it is the level expected to be required for most field waters. The DI water and salt solutions were made as in Example 80 above. Observations were made initially-1 and at various times. DI water was used in all solutions. The observations for the various formulations are shown below in Table 5. In some formulations the tests were repeated on different days to evaluate repeatability of the results.

TABLE 5

| Biocide | |
|---|---|
| Formu- | |
| lation | |
| Exam- | |
| ple No. | Observations |
| 13 | 1-soln. got opaque |
| | at 24 hours-soln. clear, no ppt., with mixing soln. got opaque |
| | 1-soln. got opaque, no ppt., no oil |
| | at 24 hours-no ppt., oil film |
| 7 | 1-particulates noted |
| 16 | 1-soln. got opaque, no ppt., no oil |
| 17 | 1-soln. got opaque, no ppt., no oil |
| 18 | 1-soln. got opaque, no ppt., no oil |
| 20 | 1-no significant change in soln. no ppt., no oil |
| | at 72 hours later-some sediment, oily film |
| 25 | 1-soln. got cloudy/opaque, no ppt., no oil |
| | at 1.5 hours-soln. hazy, no ppt., no oil, no change on stirring |
| | at 19 hours-soln. hazy, no ppt., no oil |
| | at 89 hours-soln. hazy, no ppt., no oil, no change on stirring |
| | 1-soln. hazy, no ppt., no oil |
| | at 1 hour-soln. hazy, no ppt., very small oil drops, no change on |
| | stirring |
| | at 3 hours-soln. hazy, no ppt., very small oil drops(?) or |
| | surface material in middle(?), no change on stirring |
| | at 67 hours-soln. hazy, no ppt., no oil, no change on stirring |
| 27 | 1-soln. opaque, no ppt., no oil |
| | at 1.5 hours-soln. hazy, no ppt., no oil, no change on stirring |
| | at 19 hours-soln. hazy, no ppt., no oil, no change on stirring |
| | at 89 hours-soln. hazy, no ppt., no oil, no change on stirring |
| | 1-soln. hazy, no ppt., no oil |
| | at 1 hour-soln. hazy, no ppt., very small oil drops, no change on |
| | stirring |
| | at 3 hours-soln. hazy, no ppt., no oil, some (little) surface |
| | material, no change on stirring |
| | at at 67 hours-soln. hazy, no ppt., no oil, no change on stirring |
| | 1-soln. opaque, no ppt., no oil |
| | at 2 hours-soln. hazy, no ppt., no oil, small amt. of surface |
| | material, opaque with mixing |
| | at 18 hours-soln. hazy, no ppt., no oil, with mixing soln. got a |
| | bit more hazy |
| | at 27 hours-soln. hazy, no ppt., no oil, with mixing no change |
| | at 42 hours-soln. hazy, no ppt., no oil, with mixing no change |
| | at 114 hours-soln. hazy, no ppt., no oil, with mixing no change |
| | 1-soln. hazy, no ppt., no oil |
| | at 3 hours-soln. hazy, no ppt., a 1 mm (oil” drop on surface, |
| | w mixing soln. hazy |
| | at 68 hours-soln. hazy, no ppt., no oil, w mixing soln. hazy |
| | at 92 hours-soln. hazy, no ppt., no oil, w mixing no change |
| 28 | 1-soln. hazy, no ppt., no oil |
| | at 1 hour-soln. hazy, no ppt., no oil, some surface material, with |
| | stirring soln. got more hazy |
| | at 3 hours-soln. hazy, no ppt., no oil, no change on stirring |
| | at 67 hours-soln. hazy, no ppt., no oil, some material that mixes |
| | in |
| 29 | 1-soln. hazy, no ppt., no oil |
| | at 1 hour-soln. hazy, no ppt., no oil, some surface material, |
| | with stirring soln. got a little more hazy |
| | at 3 hours-soln. hazy, no ppt., no oil, no change on stirring |
| | at 67 hours-soln. hazy, no ppt., no oil, some material that |
| | mixes in |
| 32 | 1-soln. cloudy/opaque, no ppt., no oil |
| | at 2 hours-soln. opaque (not as much as with 500 ppm PCMX), |
| | some material noted in soln., no oil, w mixing material |
| | disposed, no change in opacity |
| | at 18 hours-soln. opaque, fine ppt., no oil, no change w mixing, |
| | fine ppt. mixed in |
| | at 26 hours-soln. opaque, no ppt. (?), no oil, no change w |
| | gentle mixing |
| | at 42 hours-soln. opaque (not as much as with 500 ppm PCMX), |
| | fine sediment/ppt., no oil, no change w gentle mixing |
| | at 140 hours-soln. opaque (less than for 500 ppm PCMX), fine |
| | sediment, no oil, no change w mixing, sediment mixed in |
| 34 | 1-soln. cloudy/opaque, ppt., no oil |
| | at 2 hours-soln. opaque, some sediment (ppt. ?), no oil, w |
| | mixing material disposed, no noticeable change in opacity |
| | at 18 hours-soln. opaque (less than with 500 ppm PCMX), fine |
| | ppt., no oil, no change on mixing w fine ppt. mixed in |
| | at 26 hours-soln. opaque, very fine sediment, no oil, no change |
| | w gentle mixing |
| | at 42 hours-soln. opaque (less than with 500 ppm PCMX), fine |
| | sediment, no oil, w gentle mixing no change |
| | at 140 hours-soln. opaque (less than w 500 ppm PCMX), fine |
| | sediment, no oil, w gentle mixing no change, sediment mixed in |
| 73 | 1-soln. hazy, no ppt., no oil |
| | At 1.5 hours-soln. hazy, no ppt., no oil, w mixing no change |
| | At 22 hours-soln. hazy, no ppt., no oil, w mixing no change |
| | At 43 hours-soln. hazy, no ppt., no oil, w mixing no change |
| | At 116 hours-soln. hazy, no ppt., no oil, w mixing no change |

ppt. = precipitate; soln. = solution; sl. = slightly; w = with

The biocide formulations in Example 7 appears suitable for most waters tested. In adding the biocide formulations the more vigorous the mixing the better. Emulsion technology generally relies on good mixing of the water and emulsion product; this was shown to be particularly important for the biocide formulation of Example 13. For the high salt concentration waters the anionic biocide formulations (Examples 13, 16 and 18) produced less precipitate. Also, a water treatment chemical precipitates materials that are precipitated by the anionic surfactant containing biocide formulations. Clarity of the solution is very likely related to the particle size of the emulsion and this is likely related to the salt concentration and pH.

Comparatively the biocide formulation of Example 27 looked better than Example 25. Comparative testing of biocide formulations of Examples 25, 27, 28 and 29, showed 27 and 29 to be better. Formulation 73 performed very well.

### Example 82

This Example is presented to evaluate select biocide formulations from Examples 1-78 at a concentration of 100 ppm PCMX. Deionized water with 6% potassium chloride and 0.5% calcium chloride (salt water) was studied as well as deionized water with 2% sodium chloride added, along with a control with plain deionized water. The deionized water and salt solutions were made as described in Example 80 above.

Observations were made initially-1, after last solution prepared-2, 3 hours after start of study-3, about 24 hours after start-4, about 33 hours after start-5, about 48 hours after start-6, and about 120 hours after start-7 or as otherwise noted. The observations are shown below in Table 6.

TABLE 6

| Formu- | |
|---|---|
| lation | |
| Exam- | |
| ple No. | Observations |
| 7 with | 1-ppt. formed, soln. clear, no oil |
| salt water | 2-ppt. settled, no oil, soln. clear |
| | 3-ppt. on bottom mostly, no oil, soln. clear |
| | 4-no further changes |
| | 5-no further changes |
| | 6-no further changes |
| 7 with | 1-soln. clear, no oil, no ppt. |
| DI water | 2-no change |
| | 3-no change |
| | 4-small area of whitish material that mixed in with |
| | gentle stirring |
| | 5-soln clear |
| | 6-soln. clear |
| 7 with | 1-whitish tint (possible air entrapment), no oil, no ppt. |
| 2% NaCl | 2-soln. clear |
| | 3-soln. clear, no change |
| | 4-no change |
| | 5-no change |
| | 6-no change |
| 22 with | 1-soln. got opaque, oily drops |
| salt water | 2-film on sides/center, opaque, no oil noted |
| | 3-opaque, waves of material that mix in |
| | 4-light opaque, cloud mixes in, no oil, no ppt. |
| | 5-some surface material, mixes in |
| | 6-some surface material, no ppt., no oil |
| 24 with | 1-opaque, ppt. formed |
| salt water | 2-some film surface edge, fine oil-like particles |
| | 3-soln. nearly clear, no ppt., 1 very small oil drop on surface |
| | 4-sl. opaque, no ppt., no oil |
| | 5-light opaque, no ppt, no oil |
| | 6-no surface material, no ppt., no oil |
| | 7-no ppt., no oil, some surface material |
| 25 with | 1-fine ppt. formed, soln. got whitish |
| salt water | 2-soln. cloudy, a 1 mm oil drop on surface |
| | 3-soln. near clear, no ppt., no oil |
| | 4-sl. opaque, no ppt., no oil |
| | 5-sl. opaque, no ppt., no oil |
| | 6-no surface material, no ppt., no oil |
| | 7-no ppt., no oil, some surface material |
| 26 with | 1-ppt. (looked oil like, rise to surface) formed |
| salt water | 2-soln. clear, oily drops on edge |
| | 3-some surface material, soln. clear |
| | 4-soln. clear, some surface material when stirred in soln. |
| | opaque |
| | 5-some granular ppt., surface material, soln. clear |
| | 6-some surface material, some ppt., soln. clear, no oil |
| 27 with | 1-soln. opaque, no ppt. |
| salt water | 2-soln. cloudy, no oil |
| | 3-soln. opaque, no ppt., no oil |
| | 4-some surface material that mixes in, soln. cloudy |
| | 5-sl. opaque, no ppt., no oil |
| | 6-opaque, some surface material, no ppt., no oil |
| | 7-no ppt., no oil, some surface material |
| 28 with | 1-opaque |
| salt water | 2-cloudy, spot of whitish material on surface that gently |
| | mixes in |
| | 3-opaque, no ppt., no oil |
| | 4-opaque, some surface material, no ppt., no oil |
| | 5-sl. opaque, some surface material |
| | 6-some surface material, no ppt., no oil |
| | 7-no ppt., no oil, some surface material |
| 29 with | 1-cloudy/opaque, fine ppt. |
| salt water | 2-cloudy, no oil |
| | 3-opaque, no ppt., no oil |
| | 4-opaque, some surface material, no ppt., no oil |
| | 5-sl. opaque, no ppt., no oil |
| | 6-opaque, no ppt., no oil |
| | 7-no ppt., no oil, some surface material |
| 73 with | 1-soln. hazy, no ppt., no oil |
| salt water | At 1.5 hours-soln. hazy, no ppt., no oil, w mixing no change |
| | At 22 hours-soln. hazy, no ppt., no oil, w mixing no change |
| | At 43 hours-soln. hazy, no ppt., no oil, w mixing no change |
| | At 116 hours-soln. hazy, no ppt., no oil, w mixing no change |

ppt. = precipitate; soln. = solution; sl. = slightly

The results suggest that the water type makes a difference. Biocide formulation from Example 7 was evaluated in 3 different waters (DI water, 6% potassium chloride and 0.5% calcium chloride, and 2% sodium chloride).

Separation of material (not oily) occurs in some cases and relates to the time between stiffing or mixing even though this stiffing or mixing was very gentle and minimal. When surface material is present it mixes in well with gentle stirring.

### Example 83

This Example is presented to evaluate the biocide formulation of Examples 7 and 63, at a concentration of 500 ppm PCMX, in deionized water with 2% sodium chloride and 0.05% calcium chloride added to the deionized water. The DI water and salt solutions were made as in Example 80 above. Observations were made initially-1, and after noted times. The observations for the formulations are shown below in Table 7.

TABLE 7

| Formu- | |
|---|---|
| lation | |
| Exam- | |
| ple No. | Observations |
| 7 | 1-soln. opaque/translucent, fine suspended ppt., no oil |
| | At 2 hours-soln. clear with suspended and settled ppt. no oil, w |
| | mixing soln. opaque/translucent with mixed in ppt. |
| | At 22 hours-soln. clear, fluffy ppt., no oil, w mixing soln. |
| | opaque with ppt. mixed in |
| | At 48 hours-soln. clear, fluffy sedimented ppt., no oil, w mixing |
| | sediment mixed in (suspended) |
| 63 | 1-soln. opaque/translucent, no ppt., no oil |
| | 2-soln. opaque/translucent, fine sediment, no oil, w mixing no |
| | change, sediment mixed in |
| | At 22 hours-soln. opaque/translucent, fine sediment, no oil, w |
| | mixing soln. opaque/translucent w sediment mixed in |
| | At 48 hours- soln. opaque/translucent, fine sediment, no oil, w |
| | mixing soln. opaque/translucent w sediment mixed in |

### Example 84

This Example is presented to evaluate various biocide formulations, at a concentration of 200 ppm PCMX, shown in Examples 1-78 above in deionized water with 2% sodium chloride and 0.05% calcium chloride. One “control” solution was tested with no salt. The DI water and salt solutions were made as in Example 80 above. Observations were made initially-1, after about 5 hours-2 from start, after about 24 hours-3 after start, and about 45 hours-4 after start of study, and after other noted time. The observations for the various formulations are shown below in Table 8.

TABLE 8

| Formu- | |
|---|---|
| lation | |
| Exam- | |
| ple No. | Observations |
| 7 with | 1-soln. cloudy, ppt. formed, no oil |
| 2% NaCl/ | 2-soln. has sl. whitish tint, ppt. on bottom, no oil |
| CaCl2 | 3-soln. clear, ppt. on bottom, no oil |
| water | 4-soln. clear, ppt. on bottom |
| 7 with | 1-soln. whitish tint, fine suspended ppt., no oil |
| no salt | At 2 hours-soln. whitish tint, fine ppt., no oil, w |
| (control) | mixing sediment mixed in (suspended) |
| | At 22 hours-soln. clear, fluffy ppt., no oil, w |
| | mixing sediment mixed in (suspended) |
| | At 48 hours- soln. clear, fluffy sedimented ppt., |
| | no oil, w mixing sediment mixed in (suspended) |
| 25 with | 1-soln. hazy, fine ppt. formed, no oil |
| 2% NaCl/ | 2-soln. hazy, no ppt., no oil, some suspended material |
| CaCl2 | (?), no soln. change with gentle stirring |
| water | 3-soln. hazy, no ppt., no oil, no change with stirring |
| | 4-soln. hazy, no ppt., no oil, no change with stirring |
| 27 with | 1-soln. hazy, ppt. formed, no oil |
| 2% NaCl/ | 2-soln. hazy, no ppt., no oil, some suspended material |
| CaCl2 | that stirred in |
| water | 3-soln. hazy, no ppt., no oil, stirring caused no change |
| | (there is a time dependency noted in observations) |
| | 4-soln. hazy, no ppt., no oil, no change with stirring |
| 28 with | 1-soln. hazy (most of all samples), no ppt., no oil |
| 2% NaCl/ | 2-soln. hazy, no ppt., no oil, no soln. change with |
| CaCl2 | gentle stirring |
| water | 3-soln. hazy, no ppt., no oil, suspended whitish |
| | material, some clumps, stirring caused no change |
| | 4-soln. hazy, no ppt., no oil, some minor clumps of |
| | material suspended, with stirring material mixed in |
| 29 with | 1-soln. hazy, no ppt., no oil |
| 2% NaCl/ | 2-soln. hazy, no ppt., no oil, no soln. change with |
| CaCl2 | gentle stirring |
| water | 3-soln. hazy, no ppt., no oil, stirring caused no change |
| | 4-soln. hazy, no ppt., no oil, some material (minimal) |
| | suspended, with stirring material mixed in |
| 63 with | 1-soln. opaque/translucent, no ppt., no oil |
| 2% NACl/ | At 2 hours-soln. hazy, no ppt., no oil, w mixing no change |
| CaCl₂ | At 22 hours-soln. hazy, very fine sediment, no oil, w |
| water | mixing no change, sediment mixed in |
| | At 48 hours-soln. hazy, slight very fine sediment, no |
| | oil, w mixing no change |

ppt. = precipitate; soln. = solution; sl. = slightly, w = with

The results indicate that the presence of calcium chloride causes changes not seen without it. In particular, for the biocide formulation of Example 7 a precipitate is formed initially when calcium chloride is present. The amount of precipitate is related to the level of calcium chloride present. No precipitate is observed when calcium chloride is not present.

There are fewer changes compared to testing with higher salt levels (6% potassium chloride and 0.5% calcium chloride. With less salt present, no oil separation was ever noted. Some sedimented or surface material was noted in some cases, but this material mixed in well when the solution was gently stirred. This suggests that with those formulations a periodic mixing of the solution would be useful to keep it suspended.

### Example 85

This Example is presented to evaluate various biocide formulations, at a concentration of 100 ppm PCMX, shown in Examples 1-78 above in deionized water with 2% sodium chloride and 0.05% calcium chloride added. One “control” solution was tested with no salt. The DI water and salt solutions were made as in Example 80 above. Observations were made initially-1, after about 5 hours-2, after about 24 hours-3, after about 45 hours-4, after the start of the study, and at other noted times. The observations for the various formulations are shown below in Table 9.

TABLE 9

| Formu- | |
|---|---|
| lation | |
| Exam- | |
| ple No. | Observations |
| 7 with | 1-soln. clear, fine ppt. formed, no oil |
| 2% NaCl/ | 2-soln. clear, ppt. on bottom, no oil |
| CaCl2 | 3-soln. clear, ppt. on bottom (less than for comparable |
| water | formulation with 200 ppm), no oil |
| | 4-soln. clear, ppt. on bottom (less than for comparable |
| | formulation with 200 ppm), no oil |
| 7 with | 1-soln. light whitish tint, fine suspended ppt. formed, no oil |
| no salt | At 2 hours-soln. clear, fine ppt., no oil, w mixing sediment |
| (control) | mixed in (suspended) |
| | At 22 hours-soln. clear, fine ppt., no oil, w mixing sediment |
| | mixed in (suspended) |
| | At 48 hours- soln. clear, fine ppt., no oil, w mixing sediment |
| | mixed in (suspended) |
| 25 with | 1-soln. hazy, fine ppt. formed, no oil |
| 2% NaCl/ | 2-soln. hazy, no ppt., no oil, no change with stirring |
| CaCl2 | 3-soln. hazy, no ppt., no oil, no change on stirring |
| water | 4-soln. hazy, no ppt., no oil, no change on stirring |
| 27 with | 1-soln. hazy, fine ppt. formed, no oil |
| 2% NaCl/ | 2-soln. hazy, no ppt., no oil, no change with stirring |
| CaCl2 | (possibly some material seen) |
| water | 3-soln. hazy, no ppt., no oil, no change on stirring |
| | 4- soln. hazy, no ppt., no oil, no change on stirring |
| 28 with | 1-soln. hazy, no ppt., no oil |
| 2% NaCl/ | 2-soln. hazy, no ppt., no oil, no change on stirring |
| CaCl2 | 3-soln. hazy (more so than with 27), no ppt., no oil, no |
| water | change on stirring |
| | 4- soln. hazy (more so than with 27), no ppt., no oil, no |
| | change on stirring |
| 29 with | 1-soln. hazy, no ppt. (?), no oil |
| 2% NaCl/ | 2-soln. hazy, no ppt., no oil, material suspended that mixes |
| CaCl2 | in |
| water | 3-soln. hazy (more so than with 27), no ppt., no oil, no |
| | change on stirring |
| | 4- soln. hazy (like 28), no ppt., no oil, no change |
| | on stirring |
| 63 with | 1-soln. clear, very small amount fine suspended ppt., no oil |
| 2% NaCl/ | At 2 hours-soln. clear, no ppt., no oil, w mixing no change |
| CaCl₂ | At 22 hours-soln. clear, no ppt., no oil, w mixing no change |
| water | At 48 hours- soln. clear, no ppt., no oil, w mixing no change |

ppt. = precipitate; soln. = solution; sl. = slightly, w = with

As noted for testing at 100 ppm PCMX, the results indicate that the presence of calcium chloride causes changes not seen without it. The amount of precipitate for the biocide formulation of Example 7 is related to the level of calcium chloride present and was less when the formulation concentration was reduced to 100 ppm from 200 ppm. In testing the biocide formulations of Examples 25 and 27 were less hazy than the formulations of Examples 28 and 29. Formulation 63 showed the least changes.

### Example 86

This Example is presented to evaluate the biocide formulations of Examples 7, 60, 63 and 73, at a concentration of 500 ppm PCMX, in deionized water with 2.5% sodium chloride added. The DI water and salt solutions were made as in Example 80 above. Observations were made initially-1, and at various times as indicated. The observations are shown below in Table 10.

TABLE 10

| Formu- | |
|---|---|
| lation | |
| Exam- | |
| ple No. | Observations |
| 60 | 1-soln. opaque/translucent, no ppt., no oil |
| | At 3 hours-soln. opaque/translucent, no ppt., no oil, w mixing no |
| | change |
| | At 23 hours- soln. opaque/translucent, fine sediment, no oil, w |
| | mixing no change |
| | At 48 hours- soln. opaque/translucent, fine sediment, no oil, w |
| | mixing no change, sediment mixed in |
| | At 70 hours- soln. opaque/translucent, fine sediment, no oil, w |
| | mixing no change, sediment mixed in |
| | At 144 hours- soln. opaque/translucent, fine sediment, no oil, w |
| | mixing no change, sediment mixed in |
| 7 | 1-soln. opaque/translucent, no ppt., no oil |
| | At 2 hours-soln. opaque/translucent, no ppt., no oil, w mixing no |
| | change |
| | At 22 hours-soln. clear, no ppt., no oil, w mixing soln. got |
| | translucent |
| | At 44 hours-soln. clear, no ppt., no oil, w mixing soln. got |
| | translucent |
| 63 | 1-soln. opaque, no ppt., no oil |
| | At 2 hours-soln. opaque/translucent, no ppt., no oil, w mixing no |
| | change |
| | At 22 hours-soln. opaque/translucent, fine sediment, no oil, w |
| | mixing fine sediment mixed in, soln. opaque/translucent |
| | At 44 hours-soln. opaque/translucent, fine sediment, no oil, w |
| | mixing no change |
| | 1-soln. opaque/translucent, no ppt., no oil |
| | Refrigerated through one day some fine sediment, no oil, soln. |
| | opaque. After refrigeration and at room temperature overnight |
| | soln. translucent, fine sediment, no oil, w mixing soln. |
| | translucent. |
| 73 | At 4 hours-soln. hazy, no ppt., no oil, w mixing no change |
| | At 24 hours-soln. hazy, no ppt., no oil, w mixing no change |
| | At 48 hours-soln. hazy, no ppt., no oil, w mixing no change |
| | At 70 hours-soln. hazy, no ppt., no oil, w mixing no change |
| | 1-soln. opaque, no ppt., no oil |
| | Refrigerated through one day no ppt., no oil, soln. opaque. |
| | After refrigeration and at room temperature overnight soln. |
| | opaque, no ppt., no oil. |

ppt. = precipitate; soln. = solution; sl. = slightly, w = with

### Example 87

This Example is presented to evaluate the biocide formulations of Examples 7, 27, 63 and 73 at a concentration of 200 ppm PCMX in deionized water with 2.5% sodium chloride added. The DI water and salt solutions were made as in Example 80 above. Observations were made initially-1, and after various times as indicated. The observations are shown below in Table 11.

TABLE 11

| Formu- | |
|---|---|
| lation | |
| Exam- | |
| ple No. | Observations |
| 7 | 1-soln. got hazy, no ppt., no oil |
| | at 2 hours no change |
| | at 3 hours no change, soln. looked hazy, no change with stirring |
| | at 45 hours soln. hazy, no ppt., no oil, no change with stirring |
| | at 67 hours soln. clear to hazy, no ppt., no oil, with stirring |
| | soln. got a little more hazy |
| 27 | 1-soln. got opaque to hazy, no ppt., no oil |
| | at 1 hour soln. showed no change (more opaque than with 7), |
| | no change with stirring |
| | at 45 hours hazy, no ppt., no oil, no change with stirring |
| | at 67 hours soln. hazy (more than with 7), no ppt., no oil, no |
| | change on mixing |
| 63 | 1-soln. opaque/translucent, no ppt., no oil |
| | At 2 hours-soln. opaque/translucent, no ppt., no oil, w mixing no |
| | change |
| | At 22 hours-soln. translucent, fine sediment, no oil, w mixing |
| | sediment mixed in, soln. hazy |
| | At 44 hours-soln. translucent, very fine sediment, no oil, w |
| | mixing no change |
| 73 | 1-soln. clear, very sl. whitish tint, no ppt., no oil |
| | At 4 hours-soln. clear, very sl. whitish tint, no ppt., no oil, |
| | w mixing no change |
| | At 24 hours-soln. clear, very sl. whitish tint, no ppt., no oil, |
| | w mixing no change |
| | At 48 hours-soln. clear, very sl. whitish tint, no ppt., no oil, |
| | w mixing no change |
| | At 70 hours-soln. clear, very sl. whitish tint, no ppt., no oil, |
| | w mixing no change |

ppt. = precipitate; soln. = solution; sl. = slightly, w = with

### Example 88

This Example is presented to evaluate the biocide formulations of Examples 7, 3 and 73 at a concentration of 100 ppm PCMX in deionized water with 2.5% sodium chloride added. The DI water and salt solutions were made as in Example 80 above. Observations were made initially-1, and at various times indicated. The observations are shown below in Table 12.

TABLE 12

| Formu- | |
|---|---|
| lation | |
| Exam- | |
| ple No. | Observations |
| 7 | 1-soln. clear, no ppt., no oil |
| | At 2 hours-soln. clear, no ppt., no oil, w mixing no change |
| | At 22 hours-soln. clear, no ppt., no oil, w mixing no change |
| | At 44 hours-soln. clear, no ppt., no oil, w mixing slightly hazy |
| 63 | 1-soln. clear, no ppt., no oil |
| | At 2 hours-soln. clear, no ppt., no oil, w mixing no change |
| | At 22 hours-soln. clear, no ppt., no oil, w mixing no change |
| | At 44 hours-soln. clear, no ppt., no oil, w mixing no change |
| 73 | 1-soln. crystal clear, no ppt., no oil |
| | At 4 hours-soln. crystal clear, no ppt., no oil, w mixing no |
| | change |
| | At 24 hours-soln. crystal clear, no ppt., no oil, w mixing no |
| | change |
| | At 48 hours-soln. crystal clear, no ppt., no oil, w mixing no |
| | change |
| | At 70 hours-soln. crystal clear, no ppt., no oil, w mixing no |
| | change |

### Example 89

This Example is presented to evaluate various biocide formulations from Examples 1-78 at a concentration of 100 ppm PCMX in deionized water with 2% sodium chloride added. The DI water and salt solutions were made as in Example 80 above. Observations were made initially-1, after about 3.5 hours-2, after about 67 hours-3. The observations are shown below in Table 13.

TABLE 13

| Formu- | |
|---|---|
| lation | |
| Exam- | |
| ple No. | Observations |
| 7 with 2% | 1-soln. clear, no ppt., no oil |
| NaCl water | 2-soln. clear, no ppt., no oil |
| | 3-soln. clear, no ppt., no oil |
| 10 with 2% | 1-soln. opaque, no ppt., no oil |
| NaCl water | 2-soln. hazy, no ppt., no oil, w stirring soln. got cloudy |
| | 3-soln. clear, no ppt., no oil, w stirring soln. got cloudy |
| 22 with 2% | 1-soln. opaque (more so than Example 10), no ppt., no |
| NaCl water | oil |
| | 2-soln. opaque, no ppt., no oil, whitish, material in |
| | “plume” near top |
| | 3-soln. hazy, no ppt., no oil, some material suspended |
| | that mixes in |
| 24 with 2% | 1-ppt. formed, sl. opaque, no oil |
| NaCl water | 2-soln. clear, no ppt., no oil, w stirring soln. got more |
| | cloudy |
| | 3- sl. hazy, no ppt., no oil |
| 25 with 2% | 1-soln. opaque, ppt. formed, no oil |
| NaCl water | 2-hazy, no ppt., no oil |
| | 3-hazy, no ppt., no oil |
| 26 with 2% | 1-soln. opaque, fine ppt. formed, no oil |
| NaCl water | 2-soln. hazy, no ppt., no oil, w stirring soln. got more |
| | cloudy |
| | 3-soln. clear, no ppt., no oil, some sedimented material |
| 27 with 2% | 1-soln. opaque, fine ppt., no oil |
| NaCl water | 2-soln. hazy, no ppt., no oil, no change w stirring |
| | 3-soln. hazy, no ppt., no oil |
| 28 with 2% | 1-soln. opaque, no ppt., no oil |
| NaCl water | 2-soln. opaque, no ppt., no oil, no change w stirring |
| | 3-soln. hazy, no ppt., no oil |
| 29 with 2% | 1-soln. opaque, no ppt., no oil |
| NaCl water | 2-soln. opaque, no ppt., no oil, no change w stirring |
| | 3-soln. hazy, no ppt., no oil, some sedimented material |

ppt. = precipitate; soln. = solution; sl. = slightly, w = with

The results indicate that there are fewer changes compared to testing with 6% potassium chloride and 0.5% calcium chloride water and that with less salt no oil separation was noted. Some sedimented or surface material was noted in some cases but this material mixed in well when the solution was gently stirred. This suggests that with those formulations a periodic mixing of the solution would be useful to keep it suspended.

### Example 90

This Example is presented to evaluate various biocide formulations from Examples 1-78 at a concentration of 500 ppm PCMX in deionized water with 2.5% calcium chloride, 2.5% potassium chloride, and 7.5% sodium chloride added. The DI water and salt solutions were made as in Example 80 above. Formulation 32 was evaluated for the effects of high temperature, before and after adding biocide. Formulation 45 was also evaluated at high temperature. Observations were made initially-1, and at various indicated times. The observations are shown below in Table 14. In some formulations the tests were repeated on different days to evaluate repeatability of the results.

TABLE 14

| Formu- | |
|---|---|
| lation | |
| Exam- | |
| ple No. | Observations |
| 7 | 1-soln. clear, oil on surface |
| | At 2.5 hours-soln. clear, oil on surface, w mixing no change, oil |
| | on edge hardened |
| | At 74 hours-soln. clear, hardened oil on surface edge |
| 27 | 1-soln. hazy, no ppt., oil separation |
| | At 17 hours-soln. clear, no ppt., “oil”/material on edge, w |
| | mixing soln. got opaque |
| | At 115 hours-soln. clear, no ppt., “oil”/material on surface, w |
| | mixing soln. got opaque without oil appearance in minutes but |
| | separation noted afterwards |
| | At 189 hours-soln. clear, no ppt., “oil”/material on surface, w |
| | mixing soln. got opaque, material mixed in |
| 32 | 1-soln. opaque, no ppt., no oil |
| | At 17 hours-soln. hazy/opaque, no ppt., no oil, w mixing no |
| | change |
| | At 115 hours-soln. opaque, no ppt., no oil, some material |
| | clouds, w mixing no change, material mixed in |
| | At 189 hours-soln. opaque, no ppt., no oil, minor material |
| | ball, w mixing no change, material mixed in |
| 32 | 1-soln. opaque/translucent, no ppt., no oil |
| | At 2 hours-soln. opaque/translucent, no ppt., no oil, w mixing |
| | no change |
| | At 21 hours-soln. opaque/translucent, no ppt., no oil, w mixing |
| | no change |
| | At 26 hours-soln. opaque/translucent, no ppt., no oil, w mixing |
| | no change |
| | At 43.5 hours- soln. opaque/translucent, no ppt., no oil, w |
| | mixing no change |
| | At 69 hours- soln. opaque/translucent, no ppt., no oil, w mixing |
| | no change |
| | At about 70 hours heated soln. to 185 F. (85 C.)-soln. showed no |
| | change, if anything the translucency looked to be higher |
| 32 | 1-soln. opaque/translucent, no ppt., no oil |
| | At 2 hours-soln. opaque/translucent, no ppt., no oil, w mixing |
| | no change |
| | At 68 hours-soln. opaque/translucent, no ppt., no oil, w mixing |
| | no change |
| | At 94 hours-soln. opaque/translucent, no ppt., no oil, w mixing |
| | no change |
| | Heated “Brine solution” to 185 F. (85 C.) then added biocide |
| | formulation of Example 32, after cooling soln. volume was |
| | reduced, soln. opaque/translucent, no ppt., no oil, |
| | translucency appeared to be higher compared to same soln. |
| | not heated |
| | At about 67 hours-soln. opaque/translucent, no ppt., no |
| | oil, w mixing no change |
| | At about 93 hours- soln. opaque/translucent, no ppt., no |
| | oil, w mixing no change |
| | 1-soln. opaque, no ppt., no oil |
| | At 2.5 hours-soln. opaque/translucent, no ppt., no oil, |
| | w mixing no change |
| | At 21 hours- soln. opaque/translucent, no ppt., no oil, |
| | w mixing no change |
| | At 93 hours- soln. opaque/translucent, no ppt., no oil, |
| | w mixing no change |
| | 1-soln. opaque, no ppt., no oil |
| | At 1 hour-soln. opaque/translucent, no ppt., no oil, w |
| | mixing no change |
| | At 6 hours- soln. opaque/translucent, no ppt., no oil, w |
| | mixing no change |
| | At 73.5 hours- soln. opaque/translucent, no ppt., no oil, w |
| | mixing no change |
| | 1-soln. opaque, no ppt., no oil |
| | At 2.5 hours-soln. opaque/translucent, no pt., no oil, w |
| | mixing no change |
| | At 74 hours- soln. opaque/translucent, no pt., no oil, w |
| | mixing no change |
| | At 97 hours- soln. opaque/translucent, no pt., no oil, w |
| | mixing no change |
| 33 | 1-formulation did not mix well initially, soln. opaque, no |
| | ppt., no oil |
| | At 2.5 hours-soln. opaque/translucent, no ppt., oil drop on |
| | surface, w mixing did not notice oil drop, soln. as opaque as |
| | before |
| | At 21 hours-soln. opaque/translucent, no ppt., no oil, w mixing |
| | no change |
| | At 93 hours- soln. opaque/translucent, no ppt., no oil, w mixing |
| | no change |
| | 1-soln. opaque/translucent, no ppt., no oil |
| | At 1 hour-soln. opaque/translucent, no ppt., no oil, w mixing |
| | no change |
| | At 6 hours- soln. opaque/translucent, no ppt., no oil, w mixing |
| | no change |
| | At 73.5 hours- soln. opaque/translucent, no ppt., no oil, w |
| | mixing no change |
| 34 | 1-soln. opaque/translucent, no ppt., no oil |
| | At 1 hour-soln. opaque/translucent, no ppt., no oil, w mixing no |
| | change |
| | At 6 hours- soln. opaque/translucent, no ppt., no oil, w mixing |
| | no change |
| | At 73.5 hours- soln. opaque/translucent, no ppt., no oil, w |
| | mixing no change |
| 42 | 1-soln. opaque/translucent, no ppt., no oil |
| | At 2 hours-soln. opaque/translucent, no ppt., no oil, w mixing |
| | no change |
| | At 21 hours-soln. opaque/translucent, sediment and suspended |
| | material, no oil, w mixing materials mixed in |
| | At 26 hours-soln. opaque/translucent, no ppt., no oil, w mixing |
| | no change |
| | At 43.5 hours- soln. opaque/translucent, no ppt., no oil, w |
| | mixing no change |
| | At 69 hours-soln. opaque/translucent, no ppt., no oil, w mixing |
| | no change |
| | 1-formulation went in well, soln. opaque, no ppt., no oil |
| | At 2.5 hours-soln. opaque/translucent, no ppt., no oil, w mixing |
| | no change |
| | At 21 hours- soln. opaque/translucent, no ppt., no oil, w mixing |
| | no change |
| | At 93 hours- soln. opaque/translucent, no ppt., no oil, w mixing |
| | no change |
| | 1-soln. opaque, no ppt., no oil |
| | At 1 hour-soln. opaque/translucent, no ppt., no oil, w mixing no |
| | change |
| | At 6 hours- soln. opaque/translucent, no ppt., no oil, w mixing |
| | no change |
| | At 73.5 hours- soln. opaque/translucent, no ppt., no oil, w |
| | mixing no change |
| | 1-soln. opaque, no ppt., no oil |
| | At 2.5 hours- soln. opaque/translucent, no pt., no oil, w mixing |
| | no change |
| | At 74 hours- soln. opaque/translucent, no pt., no oil, w mixing |
| | no change |
| | At 97 hours- soln. opaque/translucent, no pt., no oil, w mixing |
| | no change |
| | At 146 hours- soln. opaque/translucent, no pt., no oil, w mixing |
| | no change |
| | At 169 hours- soln. opaque/translucent, no pt., no oil, w mixing |
| | no change |
| 43 | 1-soln. opaque/translucent, no ppt., no oil |
| | At 1 hour-soln. opaque/translucent, no ppt., no oil, w mixing |
| | no change |
| | At 6 hours- soln. opaque/translucent, no ppt., no oil, w mixing |
| | no change |
| | At 73.5 hours- soln. opaque/translucent, no ppt., no oil, w |
| | mixing no change |
| 45 | 1-initially did not mix well, soln. opaque, no ppt., no oil |
| | At 2 hours-soln. opaque/hazy, no ppt., one mm “oil” drop on |
| | surface(?), w mixing no change |
| | At 21 hours-lightest soln. of soln. tested, soln. clear, |
| | material noted (only when mixing) per bottom, no oil, w mixing |
| | soln. got opaque |
| | At 26 hours- lightest soln. of soln. tested, soln. near clear, |
| | material on bottom (noted when gently mixed), no oil, w |
| | mixing soln. got opaque |
| | At 43.5 hours- lightest soln. of soln. tested, soln. near |
| | clear, material on bottom (noted when gently mixed), |
| | no oil, w mixing soln. got opaque |
| | At about 44 hours heated soln. to 185 F. (85 C.)-soln. may |
| | have become less opaque but there were no other changes |
| | noted |
| | At 69 hours-soln. opaque/translucent, no ppt., no oil, w |
| | mixing no change |
| 46 | 1-soln. opaque/translucent but less opaque than with the |
| | formulation of Example 32, no ppt., no oil |
| | At 2 hours-soln. hazy, sedimented fluid material, oil on |
| | surface, w mixing soln. got uniformly opaque/translucent |
| | At 68 hours-soln. clear, material near bottom (noted when |
| | gently mixed), no oil, w mixing soln. got opaque/translucent |
| | At 94 hours- soln. clear, material near bottom (noted when |
| | gently mixed), no oil, w mixing soln. got opaque/translucent |
| | 1-formulation did not go in well initially, soln. opaque, no |
| | ppt., no oil |
| | At 2.5 hours-soln. hazy, liquid drops on bottom, oil drop |
| | (about 2 mm) on surface, w mixing soln. hazy and material |
| | mixed in |
| | At 21 hours-soln. clear, material on bottom, no oil, w mixing |
| | soln. got opaque/hazy |
| | At 93 hours-soln. clear, material on bottom, no oil, w mixing |
| | soln. go opaque/hazy |
| 47 | 1-soln. opaque/translucent about mid way between T33 and T45, |
| | no ppt., no oil |
| | At 2 hours-soln. hazy, sedimented fluid material, oil on |
| | surface, w mixing soln. got uniformly opaque/translucent |
| | At 68 hours-soln. clear, material near bottom (noted when |
| | gently mixed), no oil, w mixing soln. got opaque/translucent |
| | At 94 hours- soln. clear, material near bottom (noted when |
| | gently mixed), no oil, w mixing soln. got opaque/translucent |
| | 1-soln. translucent/opaque, fine droplets settled, no oil, |
| | lightest soln. compared to formulations in Examples 32, 33, |
| | 43, 46, 48, and 49 |
| | At 2.5 hours-soln. clear/hazy, material on bottom, oil |
| | (material?) on surface, w mixing material mixed in, soln. |
| | opaque/translucent |
| | At 21 hours-soln. clear, material on bottom, no oil, w mixing |
| | soln. got opaque/hazy |
| | At 93 hours- soln. clear, clear material on bottom, no oil, w |
| | mixing soln. got opaque/hazy |
| 48 | 1-formulation did go in at first, soln. opaque, no ppt., no |
| | oil |
| | At 2.5 hours-soln. opaque/translucent, no ppt., no oil, w |
| | mixing no change |
| | At 21 hours- soln. opaque/translucent, no ppt., no oil, w |
| | mixing no change |
| | At 93 hours- soln. opaque/translucent, no ppt., no oil, w |
| | mixing no change |
| | 1-soln. opaque, no ppt., no oil |
| | At 1 hour-soln. opaque, no ppt., no oil, w mixing no |
| | change |
| | At 3 hours- soln. opaque, no ppt., no oil, w mixing no |
| | change |
| | At 71 hours- soln. opaque, no ppt., no oil, w mixing no |
| | change |
| 49 | 1-formulation went in well, soln. opaque, couple of “fine” |
| | droplets on bottom, no ppt., no oil |
| | At 2.5 hours-soln. opaque/translucent, no ppt., oil on surface, |
| | w mixing oil (material?) mixed in, soln. got opaque/translucent |
| | At 21 hours-soln. opaque/translucent, no ppt., no oil, w |
| | mixing no change |
| | At 93 hours- soln. opaque/translucent, no ppt., no oil, w |
| | mixing no change |
| | 1-soln. opaque, no ppt., no oil |
| | At 1 hour- soln. opaque, no ppt., no oil, w mixing no |
| | change |
| | At 3 hour- soln. opaque, no ppt., no oil, w mixing no |
| | change |
| | At 71 hours- soln. opaque, no ppt., no oil, w mixing no |
| | change |
| 50 | 1-soln. opaque/translucent, no ppt., no oil |
| | At 1 hour-soln. hazy, no ppt., large oil drop on surface, w |
| | mixing oil drop mixed in, soln. more opaque |
| | At 2 hours-soln. is clearwith oildrops (pool) |
| 51 | 1-soln. opaque/translucent, no ppt., no oil |
| | At 1 hour-soln. clear, no ppt., oil on surface, w mixing |
| | soln. opaque/translucent; with setting about 5 minutes |
| | soln. shows separation |
| 52 | 1-soln. hazy, no ppt., oil drops on surface |
| | At 1 hour-soln. hazy, no ppt., oil drops on surface, w |
| | mixing oil drop mixed in, soln. more opaque |
| | At 2 hours-soln. clear with oil pool on surface |
| 53 | 1-soln. opaque/translucent, no ppt., no oil |
| | At 1 hour- soln. opaque/translucent, no ppt., no oil, w |
| | mixing no change |
| | At 3 hours- soln. opaque/translucent, no ppt., no oil, w |
| | mixing no change |
| | At 71 hours- soln. opaque/translucent, no ppt., no oil, w |
| | mixing no change |
| 54 | 1-soln. hazy, fine droplets (appear to not have mixed in), |
| | no oil |
| | At 1 hour-soln. hazy, fine ppt., no oil, w mixing fine ppt. |
| | remained |
| | At 3 hours-soln. hazy, fine ppt., no oil, w mixing ppt. |
| | remained |
| 55 | 1-soln. opaque/translucent, no ppt., no oil |
| | At 1 hour-soln. opaque/translucent, no ppt., no oil, w |
| | mixing no change |
| | At 6 hour-soln. hazy, w slight movement noted material on |
| | bottom, no oil, w mixing soln. got opaque/translucent |
| | At 73.5 hours-soln. clear/hazy, no ppt., no oil, some |
| | material toward bottom, w mixing soln. got |
| | opaque/translucent |
| 56 | 1-soln. opaque/translucent, no ppt., no oil |
| | At 1 hour-soln. opaque/translucent, no ppt., no oil, w |
| | mixing no change |
| | At 6 hours- soln. opaque/translucent, no ppt., no oil, w |
| | mixing no change |
| | At 73.5 hours- soln. opaque/translucent, no ppt., no oil, |
| | w mixing no change |
| 57 | 1-soln. opaque/translucent, no ppt., no oil |
| | At 1 hour-soln. opaque/translucent, no ppt., no oil, w |
| | mixing no change |
| | At 6 hours- soln. hazy, material on bottom, no oil, w |
| | mixing soln. got opaque/translucent |
| | At 73.5 hours-soln. clear/hazy, no ppt., no oil, some |
| | material toward bottom, w mixing soln. got opaque/translucent |
| 58 | 1-soln. opaque/translucent, no ppt., no oil |
| | At 3.5 hours-soln. opaque/translucent, no ppt., no oil, w |
| | mixing no change |
| | At 19 hours-soln. hazy, material on bottom, no oil, w |
| | mixing soln. opaque/translucent |
| | At 93 hours-soln. hazy, material on bottom, no oil w |
| | mixing soln. got opaque/translucent |
| 59 | 1-soln. opaque, no ppt., no oil |
| | At 2.5 hours- soln. opaque/translucent, no pt., no oil, w |
| | mixing no change |
| | At 74 hours- soln. opaque/translucent, no pt., no oil, w |
| | mixing no change |
| | At 97 hours- soln. opaque/translucent, no pt., no oil, w |
| | mixing no change |
| 60 | 1-soln. opaque/translucent, no ppt., no oil |
| | At 3 hours-soln. opaque/translucent, no ppt., no oil, w |
| | mixing no change (soln. is most translucent vs. in 2.5% |
| | NaCl or 6% KCl with 0.5% CaCl2) |
| | At 23 hours-soln. opaque/translucent, no ppt., no oil, w |
| | mixing no change |
| | At 48 hours-soln. opaque/translucent, no ppt., no oil, w |
| | mixing no change |
| | At 70 hours-soln. opaque/translucent, no ppt., no oil, w |
| | mixing no change |
| | At 144 hours-- soln. opaque/translucent, no ppt., no oil, w |
| | mixing no change |
| | 1-soln. opaque/translucent, no ppt., no oil |
| | At 2 hours- soln. opaque/translucent, no ppt., no oil, w |
| | mixing no change |
| | At 24 hours- soln. opaque/translucent, no ppt., no oil, w |
| | mixing no change |
| | At 46 hours- soln. opaque/translucent, no ppt., no oil, w |
| | mixing no change |
| | At 120 hours- soln. opaque/translucent, no ppt., no oil, w |
| | mixing no change |
| 61 | 1-soln. opaque, no ppt., no oil |
| | At 2 hours-soln. hazy/translucent, no ppt., no oil, w |
| | mixing no change |
| | At 69 hours- soln. hazy/translucent, no ppt., no oil, w |
| | mixing no change |
| | At 95 hours- soln. hazy/translucent, no ppt., no oil, w |
| | mixing no change |
| | At 122 hours- soln. hazy/translucent, no ppt., no oil, w |
| | mixing no change |
| 63 | 1-soln. opaque/translucent, no ppt., no oil |
| | At 3 hours-soln. hazy, no ppt., no oil, w mixing soln. |
| | opaque/translucent |
| | At 21 hours-soln. hazy, no ppt., no oil, w mixing soln. |
| | opaque/translucent |
| | At 45 hours-soln. opaque/translucent, no ppt., no oil, w |
| | mixing no change |
| | At 118 hours- soln. opaque/translucent, no ppt., no oil, w |
| | mixing no change |
| | 1-soln. opaque, no ppt., no oil |
| | Refrigerated through 3 days, soln. opaque, no sediment, no oil. |
| | After refrigeration and at room temperature overnight soln. |
| | hazy/clear, no ppt., no oil, w mixing got translucent. |
| 64 | 1-soln. hazy, fine droplets suspended, no ppt., no oil |
| | At 1 hour-soln. hazy, no ppt., surface oil, w mixing some |
| | surface material broken up, oil on surface |
| | At 24 hours-soln. hazy, no ppt., oil on surface, w mixing soln. |
| | got opaque/translucent w oil separating out in less than an hour |
| | At 115 hours- soln. hazy, no ppt., oil on surface, w mixing soln. |
| | got opaque/translucent |
| 65 | 1-soln. opaque, no ppt., no oil |
| | At 1 hour-soln. opaque, no ppt., no oil, w mixing no change |
| | At 19 hours-soln. hazy, no ppt., no oil, soln. has uniformly |
| | “suspended” material (like undissolved), w mixing no |
| | change |
| | At 24 hours-soln. hazy, no ppt., no oil, w mixing no change |
| | 1-soln. opaque, no ppt., no oil |
| | At 2 hours-soln. clear, no ppt., no oil, some “material” in |
| | suspension, w mixing soln. opaque (but not as opaque as |
| | prior sample) |
| | At 67 hours-soln. hazy, no ppt., some suspended “material”, |
| | no oil, w mixing soln. got more hazy |
| | At 74 hours-soln. hazy, no ppt., no oil, w mixing no changeAt |
| | 91 hours - soln. hazy, no ppt., no oil, w mixing no change |
| | At 91 hours - soln. hazy, no ppt., no oil, w/mixing no change |
| 66 | 1-soln. clear, fine particles, some surface “oil” like |
| | particles |
| | At 1 hour-soln. clear, no ppt., surface film and hardened “oil- |
| | like” particles, w mixing no change, surface film adheres to |
| | beaker at surface edge |
| | At 19 hours-soln. clear, no ppt., surface “waxy” material and |
| | on beaker edge at surface, w mixing no change |
| | At 24 hours- soln. clear, no ppt., surface “waxy” material and |
| | on beaker edge at surface, w mixing no change |
| | At 90 hours- soln. clear, no ppt., surface “waxy” material and |
| | on beaker edge at surface, w mixing no change |
| 71 | 1-soln. opaque, no ppt., no oil |
| | At 3 hours-soln. clear with fine oil like suspended particles, |
| | no ppt. |
| | At 16 hours-soln. clear, noppt., oily slick on the surface, w |
| | mixing soln. got opaque |
| | At 24 hours-soln. clear, no ppt., separation of “oily” material, |
| | with mixing soln. got opaque |
| | At 40 hours-soln. hazy, no ppt., no oil, w mixing no change |
| 72 | 1-soln. clear, no ppt., surface oil |
| | At 5.5 hours-soln. clear, no ppt., surface “coagulated” oil on |
| | surface edge, w mixing no change |
| 73 | 1-soln. opaque, no ppt., no oil |
| | At 1 hour-soln. opaque, no, ppt., no oil, w mixing no change |
| | At 3.5 hours- soln. opaque, no, ppt., no oil, w mixing no |
| | change |
| | At 21 hours-soln. opaque, no ppt., no oil, w mixing no change |
| | At 24 hours- soln. opaque, no ppt., no oil, w mixing no change |
| | SOLUTION USED FOR TEMPERATURE STUDY |
| | AT 2400 ppm PCMX |
| | 1-soln. opaque, whitish, no ppt., no oil |
| | At 2 hours-soln. opaque, no ppt., no oil, w mixing no change |
| | At 19 hours-soln. opaque, no ppt., no oil, w mixing no change |
| | At 26 hours-soln. opaque, no ppt., no oil, w mixing no change |
| | At 92 hours-soln. opaque, no ppt., no oil, w mixing no change |
| | 1-soln. opaque, no ppt., no oil |
| | At 4 hours-soln. opaque, no ppt., no oil, w mixing no change |
| | At 70 hours-soln. opaque, no ppt., no oil, w mixing no change |
| | At 96 hours-soln. hazy, no ppt., no oil, w mixing no change |
| | At 120 hours-soln. hazy, no ppt., no oil, w mixing no change |
| | 1-soln. opaque, no ppt., no oil |
| | At 1 hour-soln. opaque, no ppt., no oil, w mixing no change |
| | At 4 hours-soln. opaque, no ppt., no oil, w mixing no change |
| | At 24 hours-soln. opaque, no ppt., no oil, w mixing no change |
| | At 48 hours-soln. opaque, no ppt., no oil, w mixing no change |
| | At 70 hours-soln. opaque, no ppt., no oil, w mixing no change |
| | 1-soln., opaque, no ppt., no oil |
| | Refrigerated through days, some sediment, no oil, w mixing |
| | soln. opaque. After refrigeration and at room temperature |
| | overnight soln. opaque, no ppt., no oil. |
| 74 | 1-soln. clear, no ppt., oil particles in soln. and |
| | accumulation on the surface |
| | At 4 hours-soln. clear, no ppt., fine particulate on |
| | surface, w mixing the fine particles clumped |
| | At 70 hours- soln. clear, white particulate ppt., some |
| | surface particulate, no oil, w mixing no change |
| 75 | 1-soln. opaque, no ppt., no oil |
| | At 1 hour-soln. clear with suspended clear particles, no |
| | ppt., no oil on surface, with mixing soln. hazy |
| | At 17 hours-soln. clear, no ppt., some surface oil and |
| | globules suspended, w mixing soln. hazy |
| | At 46 hours-soln. clear w suspended globules, no ppt., no |
| | surface oil, w mixing soln. hazy |
| | At 115 hours-soln. hazy, no ppt., no oil, w mixing no change |
| 76 | 1-soln. hazy, no ppt., no oil |
| | At 1 hour-soln. clear, no ppt., no surface oil but with |
| | suspended clear material, w mixing soln. hazy (more so |
| | than 75 at that time |
| | At 17 hours-soln. clear, no ppt., some surface oil and |
| | suspended materials, w mixing soln. hazy/opaque |
| | At 46 hours-soln. hazy w suspended material, no ppt., no |
| | surface oil, w mixing soln. hazy/opaque |
| | At 115 hours-soln. hazy, no ppt., no oil, some suspended |
| | material, w mixing soln. hazy |
| 77 | 1-soln. hazy, no ppt., no oil |
| | At 1.5 hours-soln. clear, no ppt., surface “oil” on edge, w |
| | mixing soln. hazy |
| | At 67.5 hours-soln. clear, no ppt., soln. separation w “oil-like” |
| | mass, w mixing soln. hazy |
| | At 74 hours-soln. hazy, no ppt., no oil, w mixing soln. hazy |
| | At 90 hours-soln. hazy, no ppt., no oil, w mixing soln. hazy |
| | At 91.5 hours-soln. hazy, no ppt., no oil, w mixing soln. hazy |
| | At 115 hours-soln. hazy, no ppt., no oil, w mixing no change |
| 78 | 1-soln. opaque, no ppt., no oil |
| | At 1 hour-soln. opaque, no ppt., no oil, w mixing no change |
| | At 17 hours-soln. opaque, no ppt., no oil, w mixing no change |
| | At 25 hours-soln. opaque, no ppt., no oil, w mixing no change |
| | At 43 hours- soln. opaque, no ppt., no oil, w mixing no change |
| | At 67 hours-soln. opaque, no ppt., no oil, w mixing no change |
| | At 116 hours-soln. opaque, no ppt., no oil, w mixing no change |

ppt. = precipitate; soln. = solution; sl. = slightly; w = with

Evaluations were made with formulation of Example 32 both heating the saline solution to about 185° F. (85° C.) after adding the formulation to DI water and before adding the biocide formulation to the DI water. Formulation of Example 45 was also evaluated by heating (to 85° C.) the mixture of DI water and biocide formulation. With the exception of volume reduction and the solutions being more translucent after heating, no other changes were noted.

Observations were also undertaken to assess the dissolution of PCMX in the high saline solutions. The solubility of PCMX in water is 300 ppm, per its MSDS. When the temperature was raised to 85° C., there remained undissolved PCMX in crystalline form. When the temperature was lowered, a sediment appeared and undissolved material appeared in solution. It is likely that some PCMX dissolved and then recrystallized, falling out of solution at the lower temperature (less than 35° C.).

Additional evaluations were made on a DI water solution with the formulation of Example 73 at about 500 ppm PCMX. Initially the solution was crystal clear. Heating to 190 F(88 C) and then cooling it was noted that there were no changes, there was no ppt. nor separation noted. Evaluations were also made on 73 in “API” brine with 2.5% CaCl2+2.5% KCI+7.5% NaCl in DI water. The solution was initially opaque. After heating to 194 F(90 C) the only noted change was that the solution was less opaque.

Biocide formulations of Examples 32, 33, 43, 46, 48 and 49 showed no surface oil, and looked opaque suggesting these as good biocide formulations for use with high concentration brine solutions.

### Example 91

This Example is presented to evaluate various biocide formulations from Examples 1-78 at a concentration of 200 ppm PCMX in deionized water with 2.5% calcium chloride, 2.5% potassium chloride, and 7.5% sodium chloride added. The DI water and salt solutions were made as in Example 80 above. Observations were made initially-1, and at various indicated times. The observations are shown below in Table 15.

TABLE 15

| Formu- | |
|---|---|
| lation | |
| Ex. No. | Observations |
| 7 | 1-soln. clear, no ppt., oil separation (oil drops whitish) |
| | At 17 hours-soln. clear, no ppt., “hardened” oil on surface |
| | edges, w mixing “hardened” oil adhered to beaker edge |
| 27 | 1-soln. hazy, no ppt., oil separation |
| | At 17 hours-soln. clear, no ppt., “oil”/material on edge, w |
| | mixing soln. got opaque |
| | At 115 hours-soln. clear, some sedimented particles noted, |
| | “oil”/material on surface, w mixing soln. got opaque without |
| | oil appearance in minutes but separation noted afterwards |
| | At 189 hours-soln. clear, no ppt., “oil”/material on surface, w |
| | mixing soln. got opaque, material mixed in |
| 32 | 1-soln. opaque, no ppt., no oil |
| | At 17 hours-soln. hazy/opaque, fine sediment/material clump, w |
| | mixing no change and material mixed in |
| | At 115 hours-soln. opaque, fine ppt., no oil, material cloud, w |
| | mixing no change, material mixed in |
| | At 189 hours-soln. opaque, fine sediment, minor material ball, |
| | no oil, minor material ball, w mixing no change, material mixed |
| | in |
| 60 | 1-soln. hazy/translucent, no ppt., no oil |
| | At 3 hours-soln. hazy/translucent, no ppt., no oil, some “stringy |
| | material suspended (more so than with 100 ppm PCMX), w |
| | mixing soln. hazy/translucent, material mixed in |
| | At 23 hours-soln. hazy/translucent, fine sediment/string of |
| | material, no oil, w mixing soln. hazy/translucent, materials |
| | mixed in |
| | At 48 hours-soln. hazy/translucent, fine sediment/ball of |
| | material, no oil, w mixing soln. hazy/translucent, material |
| | mixed in |
| | At 70 hours- soln. hazy/translucent, fine sediment, no oil, w |
| | mixing soln. hazy/translucent, material mixed in |
| | At 144 hours- soln. hazy/translucent, fine sediment, no oil, w |
| | mixing soln. hazy/translucent, material mixed in |
| 61 | 1-soln. opaque/translucent, no ppt., no oil |
| | At 2 hours-soln. opaque/translucent, no ppt., no oil, w mixing |
| | no change |
| | At 69 hours-soln. opaque/translucent, fine sediment, no oil, |
| | w mixing no change, sediment mixed in |
| | At 95 hours- soln. opaque/translucent, fine sediment, no oil, |
| | w mixing no change, sediment mixed in |
| | At 122 hours- soln. opaque/translucent, fine sediment, no oil, |
| | w mixing no change, sediment mixed in |
| 63 | 1-soln. hazy/opaque/translucent, no ppt., no oil |
| | At 3 hours-soln. hazy/opaque/translucent, some suspended |
| | material, no ppt., no oil, w mixing soln. hazy, material mixed |
| | in |
| | At 21 hours-soln. hazy, some fine sediment and suspended |
| | material, no oil, w mixing sediment mixed in, soln. |
| | opaque/translucent |
| | At 45 hours-soln. hazy, some very fine sediment, no oil, w |
| | mixing sediment mixed in, soln. hazy |
| | At 118 hours- soln. hazy, some very fine sediment, no oil, w |
| | mixing sediment mixed in, soln. hazy |
| 63 | 1-soln. hazy, no ppt., no oil |
| | At 1 hour-soln. hazy, no ppt., no oil, w mixing no change |
| | At 22 hours-soln. hazy, no ppt., no oil, w mixing no change |
| | At 95 hours-soln. hazy, fine sediment, no oil, w mixing soln. |
| | hazy |
| | At 124 hours-soln. hazy, very fine sediment, no oil, w mixing |
| | soln. hazy |
| | At 145 hours-soln. hazy, very fine sediment, no oil, w mixing |
| | soln. hazy |
| 64 | 1-soln. hazy, fine droplets suspended, no ppt., no oil |
| | At 1 hour-soln. clear/hazy, no ppt., surface oil/material, w |
| | mixing some surface material broken up, oil on surface |
| | At 24 hours-soln. hazy, some surface “scum-like” material, no |
| | ppt., “hardened” material on top edge' w mixing surface |
| | material clumped into small particles, material on edge did not |
| | mix in |
| 73 | 1-soln. hazy (more so than at 100 ppm PCMX), no ppt., no oil |
| | At 1 hour-soln. hazy (more so than at 100 ppm PCMX), no |
| | ppt., no oil, w mixing no change |
| | At 4 hours-soln. hazy (more so than at 100 ppm PCMX), |
| | no ppt., no oil, w mixing no change |
| | At 24 hours-soln. hazy (more so than at 100 ppm PCMX), |
| | no ppt., no oil, w mixing no change |
| | At 48 hours-soln. hazy (more so than at 100 ppm PCMX), |
| | no ppt., no oil, w mixing no change |
| | At 70 hours-soln. hazy (more so than at 100 ppm PCMX), |
| | no ppt., no oil, w mixing no change |
| 78 | 1-initially didn't mix well, soln. hazy, no ppt., no oil |
| | At 1 hour-soln. hazy, no ppt., no oil, w mixing no change |
| | At 22 hours-soln. hazy, no ppt., no oil, ball of material |
| | suspended, w mixing soln. uniform and hazy |
| | At 95 hours-soln. hazy, no ppt., no oil, some “clumped” |
| | material, w mixing soln. hazy |
| | At 124 hours-soln. hazy, no ppt., no oil, w mixing no change |
| | At 145 hours- soln. hazy, no ppt., no oil, w mixing no change |

ppt. = precipitate; soln. = solution; sl. = slightly; w = with

An evaluation was also undertaken to assess the dissolution of PCMX in the high brine solution. The solubility of PCMX in water is 300 ppm per its MSDS, at 200 ppm PCMX (pH 5) the temperature was raised to 85° C. Up to this temperature there remained undissolved PCMX in crystalline form. While reducing the temperature to about 22° C., no sediment appeared. It is possible that some PCMX dissolved but not to the level of 200 ppm and there was no recrystallization on cooling.

### Example 92

This Example is presented to evaluate various biocide formulations from Examples 1-78 at a concentration of 100 ppm PCMX in deionized water with 2.5% calcium chloride, 2.5% potassium chloride, and 7.5% sodium chloride added. The DI water and salt solutions were made as in Example 80 above. Observations were made initially-1, and at various indicated times. The observations are shown below in Table 16.

TABLE 16

| Formu- | |
|---|---|
| lation | |
| Exam- | |
| ple No. | Observations |
| 60 | 1-soln. hazy/translucent, no ppt., no oil |
| | At 3 hours-soln. hazy/translucent, no ppt., no oil, some “stringy |
| | material” suspended, w mixing soln. hazy/translucent, material |
| | mixed in |
| | At 23 hours-soln. hazy/translucent, fine sediment, no oil, w |
| | mixing soln. hazy/translucent, sediment mixed in |
| | At 48 hours- soln. hazy/translucent, no ppt., no oil, w mixing |
| | no change |
| | At 70 hours-soln. hazy/translucent, no ppt., no oil, w mixing |
| | no change |
| | At 144 hours-soln. hazy/translucent, no ppt., no oil, w mixing |
| | no change |
| 61 | 1-soln. hazy/translucent, no ppt., no oil |
| | At 2 hours-soln. hazy/translucent, no ppt., no oil, w mixing no |
| | change |
| | At 69 hours- soln. hazy/translucent, fine sediment, no oil, w |
| | mixing no change, sediment mixed in |
| | At 95 hours- soln. hazy/translucent, fine sediment, no oil, w |
| | mixing no change, sediment mixed in |
| | At 122 hours- soln. hazy/translucent, fine sediment, no oil, w |
| | mixing no change, sediment mixed in |
| 63 | 1-soln. hazy, no ppt., no oil |
| | At 3 hours-soln. hazy, no ppt, no oil, w mixing no change |
| | At 21 hours-soln. hazy, some fine sediment, no oil, w mixing |
| | sediment mixed in, soln. hazy |
| | At 45 hours-soln. hazy, some very fine sediment, no oil, w |
| | mixing sediment mixed in, soln. hazy |
| | At 118 hours- soln. hazy, some very fine sediment, no oil, w |
| | mixing sediment mixed in, soln. hazy |
| 64 | 1-soln. hazy, fine droplets suspended, no ppt., no oil |
| | At 1 hour-soln. clear/hazy, no ppt., surface oil/material, w |
| | mixing surface material broken up and suspended (particulates) |
| | At 24 hours-soln. hazy, some surface “scum-like” material, not |
| | oily, no ppt., w mixing surface material clumped into some |
| | particles |
| 73 | 1-soln. hazy, no ppt., no oil |
| | At 1 hour-soln. hazy, no ppt., no oil, w mixing no change |
| | At 4 hours-soln. hazy, no ppt., no oil, w mixing no change |
| | At 24 hours-soln. hazy, no ppt., no oil, w mixing no change |
| | At 48 hours-soln. hazy, no ppt., no oil, w mixing no change |
| | At 70 hours-soln. hazy, no ppt., no oil, w mixing no change |
| 78 | 1-initially didn't mix well, soln. hazy, no ppt., no oil |
| | At 1 hour-soln. hazy (less than 78 with 200 ppm PCMX), no |
| | ppt., no oil, w mixing no change |
| | At 22 hours-soln. hazy (less than 78 with 200 ppm PCMX), |
| | no ppt., no oil, ball of material suspended, w mixing soln. |
| | uniform and hazy |
| | At 95 hours-soln. hazy, no ppt., no oil, some “clumped” |
| | material, w mixing soln. hazy |
| | At 124 hours-soln. hazy, very fine sediment, no oil, w mixing |
| | soln. hazy |
| | At 145 hours- soln. hazy, very fine sediment, no oil, w mixing |
| | soln. hazy |

ppt. = precipitate; soln. = solution; sl. = slightly; w = with

### Example 93

This Example is presented to evaluate various biocide formulations from Examples 1-78 at a concentration of 500 ppm PCMX in deionized water (no salt). The composition of Example 73 was also evaluated at 2400 ppm of the biocide. The DI water was made as in Example 80 above. The water was added to a glass beaker and gently mixed with a magnetic stirrer. The biocide formulation was then added. Observations were made initially-1 and at various noted times. The observations are shown below in Table 17.

TABLE 17

| Formu- | |
|---|---|
| lation | |
| Exam- | |
| ple No. | Observations |
| 43 | 1-soln. crystal clear, no ppt., no oil |
| | At 3.5 hours- soln. crystal clear, no ppt., no oil, w mixing no |
| | change |
| | At 19 hours- soln. crystal clear, no ppt., no oil, w mixing no |
| | change |
| | At 93 hours- soln. crystal clear, no ppt., no oil, w mixing no |
| | change |
| | At 116 hours- soln. crystal clear, no ppt., no oil, w mixing no |
| | change |
| | At 188 hours-soln. crystal clear, no ppt., no oil, w mixing no |
| | change |
| 60 | 1-soln. clear, no ppt., no oil |
| | At 3 hours-soln. clear, no ppt., no oil, w mixing no change |
| | At 23 hours-soln. clear, no ppt., no oil, w mixing no change |
| | At 48 hours- soln. clear, no ppt., no oil, w mixing no change |
| | At 70 hours- soln. clear, no ppt., no oil, w mixing no change |
| | At 144 hours- soln. clear, no ppt., no oil, w mixing no change |
| 61 | 1-soln. crystal clear, no ppt., no oil |
| | At 26 hours-soln. crystal clear, no ppt., no oil, w mixing no |
| | change |
| | At 53 hours- soln. crystal clear, no ppt., no oil, w mixing no |
| | change |
| | At 73 hours- soln. crystal clear, no ppt., no oil, w mixing no |
| | change |
| | At 99 hours- soln. crystal clear, no ppt., no oil, w mixing no |
| | change |
| | At 172 hours- soln. crystal clear, no ppt., no oil, w mixing no |
| | change |
| 63 | 1-soln. crystal clear, no ppt., no oil |
| | At 3 hours-soln. crystal clear, no ppt., no oil, w mixing no |
| | change |
| | At 21 hours-soln. crystal clear, no ppt., no oil, w mixing no |
| | change |
| | At 45 hours-soln. crystal clear, no ppt., no oil, w mixing no |
| | change |
| | At 118 hours- soln. crystal clear, no ppt., no oil, w mixing no |
| | change |
| 64 | 1-soln. crystal clear, no ppt., no oil |
| | At 1 hour-soln. crystal clear, no ppt., no oil, w mixing no change |
| | At 24 hours- soln. crystal clear, no ppt., no oil, w mixing no |
| | change |
| 65 | 1-soln. crystal clear, no ppt., no oil |
| | At 1 hour-soln. clear, no ppt., no oil, w mixing no change |
| | At 19 hours- soln. clear, no ppt., no oil, w mixing no change |
| | At 24 hours- soln. clear, no ppt., no oil, w mixing no change |
| | At 90 hours- soln. clear, no ppt., no oil, w mixing no change |
| 66 | 1-soln. w light whitish tint, no ppt., no oil |
| | At 1 hour-soln. w light whitish tint, no ppt., no oil, w mixing |
| | no change |
| | At 19 hours- soln. w light whitish tint, no ppt., no oil, w |
| | mixing no change |
| | At 24 hours- soln. w light whitish tint, no ppt., no oil, w |
| | mixing no change |
| | At 90 hours- soln. w light whitish tint, no ppt., no oil, w |
| | mixing no change |
| 72 | 1-soln. has whitish tint, no ppt., no oil |
| | At 5.5 hours-soln, opaque, whitish tint, no ppt., no oil, w |
| | mixing no change |
| | At 23 hours-soln. opaque, no ppt., no oil, w mixing no change |
| 73 | 1-soln. crystal clear, no ppt., no oil |
| | At 1 hour-soln. crystal clear, no ppt., no oil, w mixing no change |
| | At 3.5 hours- soln. crystal clear, no ppt., no oil, w mixing no |
| | change |
| | At 21 hours-soln. crystal clear, no ppt., no oil, w mixing no |
| | change |
| | At 24 hours- soln. crystal clear, no ppt., no oil, w mixing no |
| | change |
| | SOLUTION USED FOR TEMPERATURE STUDY |
| | AT 2400 PPM PCMX |
| | 1-soln. clear, no ppt., no oil |
| | At 2 hours-soln. crystal clear, no ppt., no oil, w mixing no |
| | change |
| | At 19 hours-soln. crystal clear, no ppt., no oil, w mixing no |
| | change |
| | At 26 hours- soln. crystal clear, no ppt., no oil, w mixing no |
| | change |
| | At 92 hours- soln. crystal clear, no ppt., no oil, w mixing no |
| | change |
| | 1-soln. crystal clear, no ppt., no oil |
| | At 1 hour-soln. crystal clear, no ppt., no oil, w mixing no |
| | change |
| | At 4 hours-soln. crystal clear, no ppt., no oil, w mixing no |
| | change |
| | At 24 hours-soln. crystal clear, no ppt., no oil, w mixing no |
| | change |
| | At 48 hours- soln. crystal clear, no ppt., no oil, w mixing no |
| | change |
| 74 | 1-soln. crystal clear, no ppt., no oil |
| | At 4 hours-soln. crystal clear, no ppt., no oil, w mixing no |
| | change |
| | At 70 hours-soln. crystal clear, no ppt., no oil, w mixing no |
| | change |

### Example 94

This Example is presented to evaluate Citrus Mulse (CM) as the 2-dodecoxyethanol component in various biocide formulations of Example 1-78 above, in making the biocide concentrate formulation. Also, some additional formulations were evaluated that were variations on the Examples 1-78 formulations. These additional formulations are indicated in the table below as “T” numbers (T12, T16, T18, T21, and T26-T31). The formulations were evaluated for their ability to make stable emulsions. The ingredients were mixed together and the status of the emulsion were observed. If the formulation formed a stable emulsion its status was listed as OK. If the emulsion was not stable the status was listed as Abort. The formulations and status are shown below in Table 18.

TABLE 18

| | Example No. | | | | | | | | | | |
|---|---|---|---|---|---|---|---|---|---|---|---|
| Formulation | 21 | 22 | 24 | T12 | 25 | T16 | 27 | T18 | 28 | 29 | T21 |
| CM | 40.0 | 40.0 | 30.0 | 30.0 | 35.0 | 35.0 | 40.0 | 35.0 | 40.0 | 35.0 | 35.0 |
| methyl- | — | — | 6.0 | 2.0 | 5.0 | 5.0 | — | 5.0 | — | 5.0 | 5.0 |
| oxirane | | | | | | | | | | | |
| polymer | | | | | | | | | | | |
| with oxirane | | | | | | | | | | | |
| PCMX | 10.1 | 10.1 | 10.1 | 10.1 | 10.1 | 10.1 | 10.1 | 10.1 | 10.1 | 10.1 | 10.2 |
| d-limonene | — | 10.9 | — | — | — | — | — | — | 5.45 | 5.45 | 5.43 |
| terpineol | 10.9 | — | 10.9 | 10.9 | 10.9 | 10.9 | 10.9 | 10.9 | 5.45 | 5.45 | 5.43 |
| prop. glycol | 20.0 | 20.0 | 20.0 | 20.0 | 20.0 | 15.0 | 15.0 | 15.0 | 20.0 | 20.0 | 14.9 |
| water | 19.0 | 19.0 | 23.0 | 27.0 | 19.0 | 24.0 | 24.0 | 24.0 | 19.0 | 19.0 | 24.0 |
| | 100.0 | 100.0 | 100.0 | 100.0 | 100.0 | 100.0 | 100.0 | 100.0 | 100.0 | 100.0 | 99.96 |
| STATUS | OK | OK | OK | Abort | OK | Abort | OK | Abort | OK | OK | Abort |

| | Example No. | | | | | |
|---|---|---|---|---|---|---|
| Formulation | T26 | T27 | T28 | T29 | T30 | T31 |
| CM | 35.0 | 35.0 | 35.0 | 35.0 | 35.0 | 38.0 |
| PCMX | 10.1 | 10.1 | 10.1 | 10.1 | 10.2 | 10.1 |
| d-limonene | — | 5.45 | 10.9 | — | 5.43 | — |
| terpineol | 10.9 | 5.45 | — | 10.9 | 5.43 | 10.9 |
| prop. glycol | 15.0 | 20.0 | 20.0 | 20.0 | 14.9 | 15.0 |
| water | 29.0 | 24.0 | 24.0 | 24.0 | 29.0 | 26.0 |
| | 100.0 | 100.0 | 100.0 | 100.0 | 100.0 | 100.0 |
| STATUS | Abort | Abort | Abort | Abort | Abort | Abort |

Discussion of the observations and results from this Example 94 follows below. For formulation T12 when the final concentration of methyl-oxirane polymer with oxirane was increased from 2.0% to 5.8%, the solution was still not clear. Per formulation of Example 24 (which was OK), additional methyl-oxirane polymer with oxirane may be needed in formulation T12. For formulation T21 when the level of propylene glycol was increased from 14.9% to 19.9%, the solution was clear and looked OK, but is then more comparable to the formulation of Example 29. For formulation T26 when the Citrus Mulse level was increased from 35% to 38.1%, the solution was clear, suggesting a formulation like in Example 27 could be made with as low as about 38% CM. For formulation T27 when the CM level was increased from 35% to 36.9%, the solution was clear and is approaching the formulation of Example 28 or Example 29 without the methyl-oxirane polymer with oxirane and suggests that the CM level may be as low as about 37% for the formulation of Example 28 or increased to about 37% without the methyl-oxirane polymer with oxirane. For the formulation T28, when the CM level was increased from 35% to 36.9%, the solution was clear and is approaching the formulation of Example 22. This suggests that the CM level of Example 22 may be reduced to as low as about 37%. For the formulation T29 when the level of CM was increased from 35% to 36.9%, the solution was clear and is approaching the formulation of Example 25 without the methyl-oxirane polymer with oxirane. This suggests that the level of CM may be as low as about 37% for the formulation of Example 25. For the formulation T30 when the level of CM was increased from 35% to 38.1%, the solution was clear and is approaching the formulation of T21 without the methyl-oxirane polymer with oxirane. This suggests that the level of CM may be as low as about 38% for the formulation of T21 without the methyl-oxirane polymer with oxirane. For the formulation T31 when the level of CM was increased from 38% to 39.2%, the solution was clear and is approaching the formulation of Example 27. This suggests that the minimum amount of CM is about 40% (that of Example 27) or that too much water addition made when solution turned opaque makes it difficult to reverse the cloudiness. For formulations with about 15% propylene glycol (T26 and T30), it appears that at least an additional 3% CM is needed to achieve a clear formulation, whereas for T31 an additional 2% CM was used.

### Example 95

This Example is presented to evaluate the partial or complete replacement of Citrus Mulse (CM) with Natural Mulse in four formulations (T25, T22, T23, and T24). The formulations and status are shown below in Table 19.

TABLE 19

| Formulation | T25 | T22 | T23 | T24 |
|---|---|---|---|---|
| CM | 35.0 | — | — | — |
| Natural | 5.0 | 40.0 | 40.0 | 40.0 |
| Mulse | | | | |
| PCMX | 10.1 | 10.2 | 10.1 | 10.1 |
| d-limonene | 5.45 | 5.43 | 5.45 | — |
| terpineol | 5.45 | 5.45 | 5.45 | 10.9 |
| prop. glycol | 20.0 | 14.9 | 20.0 | 15.0 |
| water | 19.0 | 24.0 | 19.0 | 24.0 |
| | 100.0 | 99.96 | 100.0 | 100.0 |
| STATUS | OK | Abort | Abort | Abort |

The data show that Natural Mulse alone does not work well. CM works well with or without methyl-oxirane polymer with oxirane or Natural Mulse. 15% propylene glycol in the formulation does not work well with 5% methyl-oxirane polymer with oxirane. For formulation T22 when the level of propylene glycol was increased from 14.9% to 18.8%, there was no appreciable change noted.

### Example 96

This Example is presented to evaluate EZ-Mulse as a replacement for Citrus Mulse. Formulation T15 along with its status is shown below in Table 20.

TABLE 20

| Formulation | T15 |
|---|---|
| EZ-Mulse | 40.0 |
| PCMX | 10.1 |
| d-limonene | — |
| terpineol | 10.9 |
| prop. glycol | 20.0 |
| water | 19.0 |
| | 100.0 |
| STATUS | Abort |

The data show that EZ-Mulse alone does not work well.

In the foregoing description, certain terms have been used for brevity, clarity and understanding, however, no unnecessary limitations are to be implied therefrom, because such terms are used for descriptive purposes and are intended to be broadly construed. Moreover, the descriptions and examples herein are by way of examples and the exemplary embodiment is not limited to the exact details shown and described.

In the following claims, any feature described as a means for performing a function shall be construed as encompassing any means known to those skilled in the art to be capable of performing the recited function, and shall not be limited to the features and structures shown herein or mere equivalents thereof. The description of the exemplary embodiment included in the Abstract included herewith shall not be deemed to limit the invention to features described therein.

Having described the features, discoveries and principles of the invention, the manner in which it is formulated and operated, and the advantages and useful results attained; the new and useful compositions, ingredients, combinations, systems, operations, methods and relationships are set forth in the appended claims.

1. A biocide composition comprising:
(a) water;
(b) at least one biocide selected from the group consisting of (i) a halogen substituted xylenol compound, (ii) a phenolic compound, (iii) an antimicrobial natural or essential oil, (iv) an antimicrobial component from natural or essential oil, and (v) combinations of at least two of (i), (ii), (iii), and (iv);
(c) at least one surfactant, wherein said surfactant is selected from the group consisting of anionic surfactant, amphoteric surfactant, nonionic surfactant, and blends thereof; and
(d) at least one solubilizing agent.

2. The biocide composition of claim 1, wherein said biocide in (b) is a halogen substituted xylenol.

3. The biocide composition of claim 2, wherein said halogen substituted xylenol is parachlorometaxylenol.

4. The biocide composition of claim 3, wherein said surfactant is selected from the group consisting of alkyl sulfates, alkyl ether sulfate, potassium ricinoleate, alkyl glucosides, and mixtures thereof.

5. The biocide composition of claim 4, wherein said surfactant is a mixture of potassium ricinoleate and sodium dodecyl sulfate.

6. The biocide composition of claim 4, wherein said surfactant is a mixture of sodium lauryl ether sulfate and D-glucopyranose, oligomeric, decyl octyl glycosides.

7. The biocide composition of claim 3, wherein said solubilizing agent is selected from the group consisting of low molecular weight alcohols having from 2 to 10 carbon atoms, glycols, terpineols, and mixtures thereof.

8. The biocide composition of claim 7, wherein said low molecular weight alcohol is isopropyl alcohol.

9. The biocide composition of claim 7, wherein said solubilizing agent is a mixture of terpineol and propylene glycol.

10. The biocide composition of claim 7, wherein said solubilizing agent is propylene glycol.

11. The biocide composition of claim 1, wherein said water is deionized water.

12. The biocide composition of claim 1, wherein said biocide is present at a level of from about 1 to about 30 weight percent.

13. The biocide composition of claim 12, wherein said biocide is present at a level of from about 5 to about 20 weight percent.

14. The biocide composition of claim 13, wherein said biocide is present at a level of from about 8 to about 12 weight percent.

15. The biocide composition of claim 1, wherein said surfactant is present at a level of from 2 to about 50 weight percent.

16. The biocide composition of claim 15, wherein said surfactant is present at a level of from about 12 to about 45 weight percent.

17. The biocide composition of claim 1, wherein said solubilizing agent is present at a level of from about 10 to about 40 weight percent.

18. The biocide composition of claim 17, wherein said solubilizing agent is present at a level of from about 20 to about 35 weight percent.

19. The biocide composition of claim 1 comprising:
(a) From about 30 to about 50 weight percent water;
(b) From about 8 to about 12 weight percent parachlorometaxylenol;
(c) From about 10 to about 14 weight percent potassium ricinoleate;
(d) From about 2 to about 4 weight percent sodium dodecyl sulfate;
(e) From about 8 to about 13 weight percent terpineol; and
(f) From about 15 to about 25 weight percent propylene glycol.

20. The biocide composition of claim 1 comprising:
(a) From about 20 to about 25 weight percent water;
(b) From about 8 to about 12 weight percent parachlorometaxylenol;
(c) From about 25 to about 35 weight percent sodium lauryl ether sulfate;
(d) From about 8 to about 12 weight percent decyl octyl glycosides;
(e) From about 8 to about 13 weight percent terpineol/pine oil; and
(f) From about 12 to about 18 weight percent propylene glycol.

21. The biocide composition of claim 1 comprising:
(a) from about 20 to about 25 weight percent water;
(b) from about 8 to about 12 weight percent parachlorometaxylenol;
(c) from about 25 to about 35 weight percent sodium lauryl ether sulfate;
(d) from about 8 to about 12 weight percent decyl octyl glycosides; and
(e) from about 25 to about 35 weight percent propylene glycol.

22. A process for producing a concentrated biocide composition comprising mixing together to form an emulsion the following ingredients:
(a) water;
(b) at least one biocide selected from the group consisting of (i) a halogen substituted xylenol compound, (ii) a phenolic compound, (iii) an antimicrobial natural or essential oil, (iv) an antimicrobial component from natural or essential oil, and (v) combinations of at least two of (i), (ii), (iii) and (iv);
(c) at least one surfactant, wherein said surfactant is selected from the group consisting of anionic surfactant, amphoteric surfactant, nonionic surfactant, and blends thereof; and
(d) at least one solubilizing agent.

23. The process of claim 22, wherein said biocide is parachlorometaxylenol.

24. The process of claim 22, wherein said water is deionized water.

25. The process of claim 22, wherein said surfactant is a mixture of potassium ricinoleate and sodium dodecyl sulfate.

26. The process of claim 22, wherein said surfactant is a mixture of sodium lauryl ether sulfate and decyl octyl glycosides.

27. The process of claim 22, wherein said solubilizing agent is a mixture of terpineol/pine oil and propylene glycol.

28. The process of claim 22, wherein said solubilizing agent is propylene glycol.

29. The process of claim 23, wherein said parachlorometaxylenol is present at a level of from about 8 to about 12 weight percent.

30. The process of claim 25, wherein said surfactant mixture is present at a level of from about 12 to about 18 weight percent.

31. The process of claim 26, wherein said surfactant mixture is present at a level of from about 33 to about 47 weight percent.

32. The process of claim 27, wherein said solubilizing agent mixture is present at a level of from about 23 to about 38 weight percent.

33. The process of claim 28, wherein said propylene glycol is present at a level of from about 25 to about 35 weight percent.

34. A hydraulic fracturing fluid suitable for fracturing subterranean formations connected to or adjacent to a drilled well bore, said fluid comprising:
(a) field water;
(b) at least one biocide selected from the group consisting of (i) a halogen substituted xylenol compound, (ii) a phenolic compound, (iii) an antimicrobial natural or essential oil, (iv) an antimicrobial component from natural or essential oil, and (v) combinations of at least two of (i), (ii), (iii), and (iv); wherein said biocide is present at a level of from about 5 to about 5000 parts per million by weight of said hydraulic fracturing fluid;
(c) at least one surfactant, wherein said surfactant is selected from the group consisting of anionic surfactant, amphoteric surfactant, nonionic surfactant, and blends thereof;
(d) at least one solubilizing agent;
(e) at least one proppant; and
(f) optionally said fluid may contain one or more ingredients selected from the group consisting of oxygen scavengers, polymers, friction reducers, viscosity modifier, corrosion inhibitors, pH adjuster, and metal chealater.

35. The hydraulic fracturing fluid of claim 34, wherein said field water is obtained from a water source selected from a source consisting of pond, river, stream, lake, water well, recycled water from a previous hydraulic fracturing job, treated water, and mixtures thereof.

36. The hydraulic fracturing fluid of claim 35, wherein said field water comprises:
(a) From 0 to 7.5 mg/L of hydrogen sulfide;
(b) From 10 to 4449 mg/L of calcium⁺⁺;
(c) From 10 to 6340 mg/L of Magnesium⁺⁺;
(d) From 0 to 59640 mg/L of sodium⁺;
(e) From 0 to 80 mg/L of barium⁺⁺;
(f) From 0 to 2257 mg/L of bicarbonate⁻;
(g) From 0 to 640 mg/L of chloride⁻;
(h) From 573 to 166,382 mg/L of dissolved solids;
(i) From 0.02 to 42 mg/L of iron;
wherein said field water has a total hardness of from 245 to 27000 mg/L, a resistivity of from 0.024 to 2.669 Ohm-m, and a pH of from 5.71 to 7.82.

37. The hydraulic fracturing fluid of claim 34, wherein said biocide is present at a level of from about 100 to about 500 ppm by weight of said fluid.

38. A method of treating an aqueous ore processing slurry, wherein said slurry contains microorganisms, said method comprising adding to said slurry a biocide composition comprising parachlorometaxylenol.

39. A method of treating process water from an oil and gas drilling operation comprising adding to said water a biocide composition comprising parachlorometaxylenol.
